(19) United States
(12) Patent Application Publication
(10) Pub. No.: US 2020/0407627 A1
(43) Pub. Date: Dec. 31, 2020

(54) MULTI-LAYER OPTICAL CONSTRUCTION OF QUANTUM DOT FILMS FOR IMPROVED CONVERSION EFFICIENCY AND COLOR GAMUT

(71) Applicant: SABIC GLOBAL TECHNOLOGIES B.V., Bergen op Zoom (NL)

(72) Inventors: Bing ZHOU, Evansville, IN (US); Hao ZHOU, Newburgh, IN (US); Christopher Luke HEIN, Evansville, IN (US)

(21) Appl. No.: 16/616,766

(22) PCT Filed: May 30, 2018
(86) PCT No.: PCT/US18/35074

§ 371 Date: Nov. 25, 2019

Related U.S. Application Data
(60) Provisional application No. 62/512,373, filed on May 30, 2017.

(51) Int. Cl. C09K 11/02; C09K 11/88

(52) U.S. Cl. CPC C09K 11/025; G02F 1/133617; C09K 11/883

(57) ABSTRACT

A multi-layer film may comprise a first quantum dot layer comprising a first polymer matrix and a plurality of first quantum dots disposed therein. A second quantum dot layer may be disposed adjacent the first quantum dot layer and may comprise a second polymer matrix and a plurality of second quantum dots disposed therein. The plurality of first quantum dots may be spaced from each other within the first polymer matrix to define gaps there between. The plurality of first quantum dots may emit a first secondary light upon excitation by light produced from a light source. At least a portion of the plurality of second quantum dots may be positioned to align with the gaps defined in the first polymer matrix along an axis that is orthogonal to the first quantum dot layer and the second quantum dot layer.

### TECHNICAL FIELD

The disclosure generally relates to multi-layer quantum dot films, and more particularly to methods and structures utilizing a quantum dot film.

### BACKGROUND

Quantum dots (QDs) represent an area of expanding technological interest as a promising class of emissive materials. QDs may be characterized as semiconductor particles with dimensions on the order of about 2 nanometers (nm) to about 100 nm and often may be referred to as nanocrystals. QDs may exhibit comparatively strong emission in the visible region of the electromagnetic spectrum. However, certain optical constructions or devices making use of quantum dots may be hindered and suffer from a reduced conversion efficiency (for example, the emission produced from absorbed light) and color gamut. That is, certain optical constructions may have quantum dots emitting less than the light energy absorbed and thus a limited array of colors available from the construction.

These and other shortcomings are addressed by aspects of the present disclosure.

### SUMMARY

The present disclosure relates to a multi-layer film for light emitting devices. According to one example, a multi-layer film may comprise a first quantum dot layer comprising a first polymer matrix and a plurality of first quantum dots disposed in the first polymer matrix. The plurality of first quantum dots may be spaced from each other within the first polymer matrix to define gaps there between. The plurality of first quantum dots may emit secondary light (e.g., emission) upon excitation by light produced from a light source. A second quantum dot layer may be disposed adjacent the first quantum dot layer. The second quantum dot layer may comprise a second polymer matrix and a plurality of second quantum dots disposed in the second polymer matrix. The plurality of second quantum dots may be disposed in the second polymer matrix such that at least a portion of the plurality of second quantum dots align with the gaps defined in the first polymer matrix along an axis that is orthogonal to the first quantum dot layer and the second quantum dot layer. The plurality of second quantum dots may emit secondary light upon excitation by light produced from the light source. In certain aspects, the first quantum dot layer may be placed in closer proximity to the light source than the second quantum dot layer, to thereby interpose the first quantum layer between the light source and the second quantum dot layer

The plurality of second quantum dots may be configured to not substantially overlap with the plurality of first quantum dots along an axis orthogonal to the first quantum dot layer and the second quantum dot layer. The first quantum dots may be spaced at a minimum of one radius of a first quantum dot and the second quantum dots may be spaced at a minimum of one radius of a second quantum dot. The first polymer matrix may have a refractive index within 2 of the refractive index of the first quantum dots and the second polymer matrix may have a refractive index within 2 of the refractive index of the second quantum dots.

In some aspects the disclosure relates to a multi-layer film comprising a first quantum dot layer and a second quantum dot layer, each layer having distinguishable portions. The first quantum dot layer may comprise a first plurality of first portions and a first plurality of second portions. The first portions may comprise a plurality of first quantum dots and the second portions may consist essentially of a first polymer matrix and one or more additives. The plurality of first portions and the plurality of second portions may be disposed in an alternating pattern. As an example, the alternating pattern may define spaces or gaps between the first quantum dots, wherein the spaces do not comprise quantum dots.

The second quantum dot layer may be disposed adjacent the first quantum dot layer. The second quantum dot layer may comprise a second plurality of first portions and a second plurality of second portions. The second plurality of first portions may comprise a plurality of second quantum dots and the second plurality of second portions may consist essentially of a second polymer matrix and one or more additives. The second plurality of first portions and second plurality of second portions may be disposed in an alternating pattern. As an example, the alternating pattern may define spaces or gaps between the second quantum dots, wherein the spaces do not comprise quantum dots. As a further example, the alternating portions of the first quantum dot layer and the alternating portions of the second quantum dot layer may be disposed such that the plurality of second quantum dots does not overlap the plurality of first quantum dots across an orthogonal axis.

The present disclosure also relates to an article comprising the disclosed multi-layer film.

### BRIEF DESCRIPTION OF THE DRAWINGS

The above-mentioned and other features and advantages of this disclosure, and the manner of attaining them, will become apparent and be better understood by reference to the following description of one aspect of the disclosure in conjunction with the accompanying drawings, wherein:

FIG. 1 is a schematic representation of a cross-section of a multi-layer film according to an aspect of the present disclosure.

FIG. 2 is a schematic representation of an overhead perspective view of a multi-layer film according to an aspect of the present disclosure.

FIG. 3 is a graphical representation of relative color intensities that may be achieved before or after application of a color filter according to an aspect of the present disclosure.

FIG. 4 is a schematic representation of a cross-section of a multi-layer film according to an alternate aspect of the present disclosure.

### DETAILED DESCRIPTION

Unique optical properties of Quantum dots (QDs) make QDs desirable for a number of diverse commercial areas including solar cells, chemical catalysis, biological imaging and labeling, and light-emitting diodes among many others. QDs may be or comprise a luminescent material (e.g., nanomaterial). QDs may be configured in various sizes to provide tunable emission wavelengths based on the size of respective QDs. Additionally, QDs may be sized to exhibit near continuous above-the-band absorption and a narrow emission spectrum at near-band-edge energies. The optical spectra of QDs depend directly on their size. Thus, their emission color may be continuously tuned from the infrared (IR) to ultraviolet (UV) by altering QD size and/or composition.

The unique properties of QDs have been explored for use in various devices such as LEDs, lasers, solar cells, photo detectors, and liquid crystal displays (LCDs). LCDs are non-emissive displays having a separate backlight unit and red, green, and blue color filters from which pixels display a color image on a screen. The red, green, and blue color filters respectively separate white light emitted from the backlight unit into red, green, and blue lights. Each of the color filters transmits only light of a narrow wavelength band and may absorb light having wavelengths outside the narrow band, resulting in significant optical loss. A high luminance backlight unit is needed to produce an image with sufficient luminance. The range of colors that may be displayed by an LCD device may be referred to as color gamut and may be determined by the combined spectra of the backlight unit and the color filters of the LCD panel.

In conventional QD multi-layer films, randomly distributed blends of quantum dots at varying sizes, which correspond to different emission wavelengths, may be suspended or dispersed throughout one or more layers of a polymer film. When used in conjunction with a blue LEI) light source, limitations arise. Random distribution of dots may result in some QDs being completely or substantially blocked by other quantum dots in the optical path from the excitation light source (e.g., the blue LED) such that the QDs are not equally exposed to the light source for excitation. Moreover, due at least in part to the mixture of varying sizes, green fluorescence from the smaller QDs may be reabsorbed by larger QDs and converted to red fluorescence. This occurrence may result in reduced conversion efficiency of the QDs because the quantum yield (here, for example, photons emitted/photons absorbed) would be less than one. Uncontrolled fluorescence light may vary the light intensity ratio or profiles of blue, red, and green in local areas.

Additionally, or alternatively, a refractive index of the polymer matrices used in conventional films containing QD's may affect overall light transmittance. More specifically, if the refractive index of the polymer matrix is significantly different from that of (a) a barrier film or (b) of other neighboring layers, or more importantly, (c) of embedded of quantum dots, light transmittance may be significantly reduced because of the increased portion of light reflectance at the interface of different materials (i.e., the polymer matrix, the different QDs). The optical construction of the present disclosure, however, provides an assembly of multi-layered quantum dot films having a selective distribution of quantum dots and particular layering of the quantum dot films to avoid certain shortcomings of conventional QD multi-layer films described herein. The disclosed optical construction may achieve improved conversion efficiency (power efficiency) and color gamut via the specific alignment of QDs and design to construct the nanocomposite in a specific way to retain high conversion efficiency. The optical construction may exploit the arrangement of QD in adjacent layers relative to one another to improve optical properties. Further, the disclosed optical construction may have a broad catalog of polymers useful as the polymer because aspects of the present disclosure tailor the polymer matrix to the quantum dots disposed therein with respect to chemical compatibility and refractive index matching.

In various aspects of the present disclosure, quantum dots of different sizes are disposed in different layers of a multi-layer film. Larger quantum dots (i.e., ranging in size from 3 nm to 11 nm, or from about 3 nm to about 11 nm) may be disposed within a first polymer matrix layer disposed adjacent a light source, such as a blue LED source. Smaller quantum dots (ranging in size from 1 nm to 8 nm, or from about 1 nm to about 8 nm) may be disposed adjacent the first quantum dot layer such that the first quantum dot layer is interposed between the second quantum dot layer and the light source. Fluorescent light emitted from the larger quantum dots are typically at a longer wavelength than the absorption band of the smaller quantum dots. Thus, the fluorescence emitted by the larger quantum dots in the first QD layer are not re-absorbed by the smaller quantum dots of the second quantum dot layer. This configuration may improve conversion efficiency by preventing the described re-absorption. Not only is conversion efficiency improved, the disclosed configuration may in some aspects provide uniform and constant ratios among the intensities of blue, green and red across the film surface. Color intensities may also be controlled which may avoid the occurrence of local defects with respect to light intensity and uniformity.

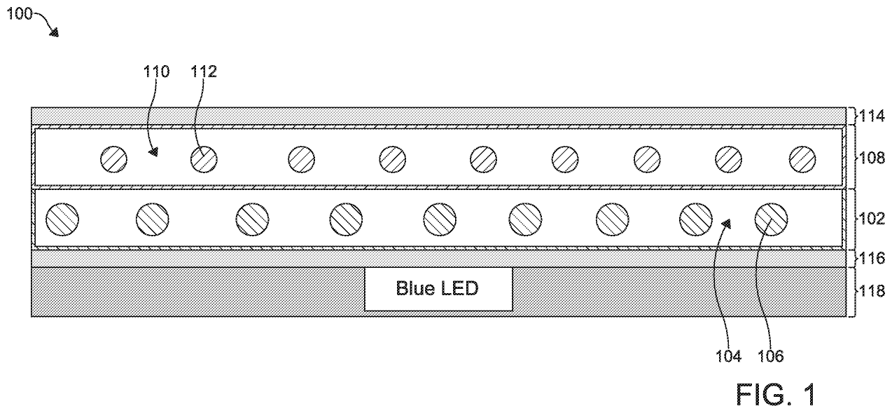

FIG. 1 illustrates a multi-layer film 100. The multi-layer film 100 may comprise a first quantum dot layer 102 comprising a first polymer matrix 104. A plurality of first quantum dots 106 may be disposed in the first polymer matrix 104. The plurality of first quantum dots 106 may be spaced from each other within the first polymer matrix 104 to define gaps or spaces there between. A second quantum dot layer 108 may be disposed adjacent the first quantum dot layer 102. The second quantum dot layer 108 may comprise a second polymer matrix 110. A plurality of second quantum dots 112 may be disposed in the second polymer matrix 110.

The gaps or spaces may refer to a portion of the polymer matrix that is free of quantum dots. The gaps or spaces may be at a minimum of one radius of a quantum dot in a given layer. For example, gaps or spaces among the plurality of first quantum dots 106 may be sized at a minimum of one radius of a first quantum dot of the plurality of first quantum dots 106. Gaps among the plurality of second quantum dots may be sized at a minimum of one radius of a second quantum dot 112. The size of the gaps (i.e., the spacing between the quantum dots in the same layer) and size of the quantum dots may be quantitatively measured by transmission electron microscopy (TEM). In one example of determining the gap size via TEM, a planar sample of the multi-layer film may be prepared and then an image obtained by transmission electron microscopy.

In certain aspects, the multi-layer film 100 may further comprise one or more barrier layers 114, 116 as described in further detail herein. The first quantum dot layer 102 may be disposed adjacent a light emitting diode (LED) light source 118, such as but not limited to a blue LED light source.

QDs of the present disclosure may be selectively disposed in the disclosed polymer matrix in a particular orientation forming a QD layer. QDs may be disposed in a polymer matrix so that they are not within the optical path of the light source of the QDs in a preceding or adjacent layer. As shown in FIG. 1, at least a portion of the plurality of second quantum dots 112 align with gaps defined in the first polymer matrix 104 along an axis that is orthogonal to the first quantum dot layer 102 and the second quantum dot layer 108. Thus, the plurality of second quantum dots 112 may not substantially overlap the plurality of first quantum dots 106 along an axis orthogonal to the first quantum dot layer 102 and the second quantum dot layer 108. The plurality of first quantum dots 106 may be spaced at a minimum of one radius of a first quantum dot of the plurality of first quantum dots 106. A second quantum dot of the plurality of second quantum dots 112 may be spaced at a minimum of one radius of a second quantum dot 112. The configuration allows the QDs of the first or second quantum dot layer 102, 108 to receive direct exposure to the transmitted blue light from LED source 118. Direct exposure may increase absorption efficiency of the quantum dots.

The pluralities of quantum dots 106, 112 of the multi-layer film 100 may have varying sizes. The varying sizes of QDs disposed in different layers 102, 108 of the multi-layer film 100 provide certain properties to the multi-layer film. At least a portion of the plurality of first quantum dots may be larger than at least a portion of the plurality of second quantum dots. In some examples, the plurality of first quantum dots 106 may comprise quantum dots having a size from 3 nm to 11 nm, or from about 3 nanometers to about 11 nanometers. Moreover, upon excitation by light produced from a light source (such as the blue light emitting diode described herein), the plurality of first quantum dots 106 emit a first secondary light excitation. Specifically, in some aspects, the plurality of first quantum dots 106 may comprise a red phosphor. In further examples, the plurality of first quantum dots 106 may be a red phosphor with a peak emission wavelength between 600 nanometers (nm) and 750 nm.

The plurality of second quantum dots 112 may comprise quantum dots sized from 1 nm to 8 nm, or from about 1 nm to about 8 nm. Thus, in various examples, the plurality of second quantum dots 112 may comprise a green phosphor. Specifically, in some aspects the plurality of second quantum dots 112 may be a green phosphor with a peak emission wavelength between 490 nm and 580 nm, or between about 490 nm and about 580 nm.

As provided herein, the plurality of first quantum dots may be selectively disposed within the first polymer matrix and the plurality of second quantum dots may be selectively disposed within the second polymer matrix. The QDs may be evenly spaced and/or uniformly distributed and disposed at the same, or about the same, depth in each layer. The spacing of quantum dots in the quantum dot layers may be carefully controlled so individual QDs are illuminated by the LED light source 118 (see FIG. 1). A uniform spatial distribution (or approximating uniform spatial distribution) of quantum dots and unobstructed light path may provide an improved homogeneity of color and higher color efficacy. The spacing or loading of larger quantum dots (e.g., plurality of first quantum dots), the spacing or loading of smaller quantum dots (e.g., plurality of second quantum dots) and correspondingly, the gaps (void space) that blue LED light may transmit through the multi-layer film, may be tuned to adjust the relative intensity of blue, green and red. The respective portions of red, green, and blue light may be controlled to achieve a desired white point for the white light emitted by a display device incorporating the quantum dot film article.

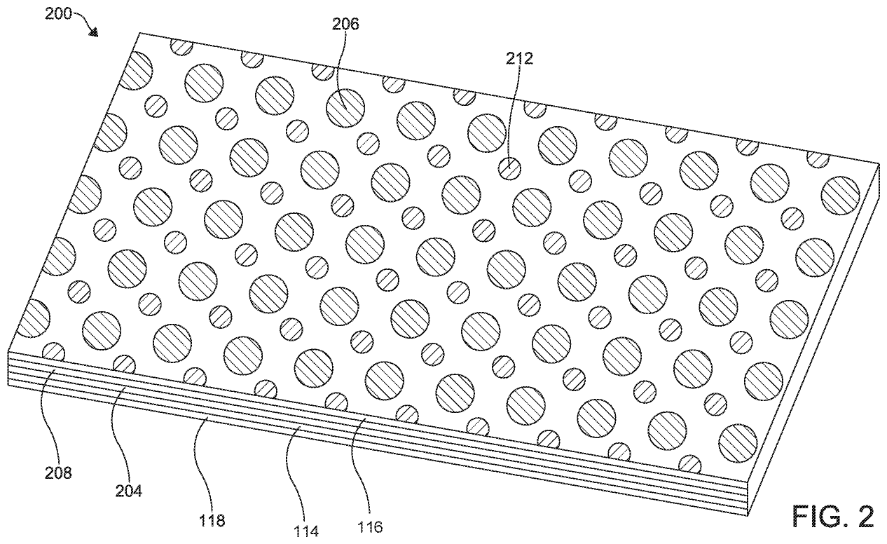

In an example, the quantum dots may be placed in a chess board or a staggered pattern. FIG. 2 provides an alternative view of the multi-layer film 200 to highlight the relation of spacing among varying layers of quantum dots. At least a portion of the plurality of second quantum dots 212 align with gaps defined in the first quantum dot layer 204. The plurality of second quantum dots 212 do not overlap, or do not substantially overlap, the plurality of first quantum dots 206 along an axis orthogonal to the first quantum dot layer 204 and the second quantum dot layer 208. As shown, the plurality of first quantum dots 206 may be spaced at a minimum of one radius of a first quantum dot of the plurality of first quantum dots 206 and the second plurality of quantum dots 212 may be spaced at a minimum of one radius of a second quantum dot of the plurality of second quantum dots 212. The first or second pluralities of QDs 206, 212 may be exposed to the transmitted blue light from the LED source 118 concurrently to allow for increased absorption efficiency.

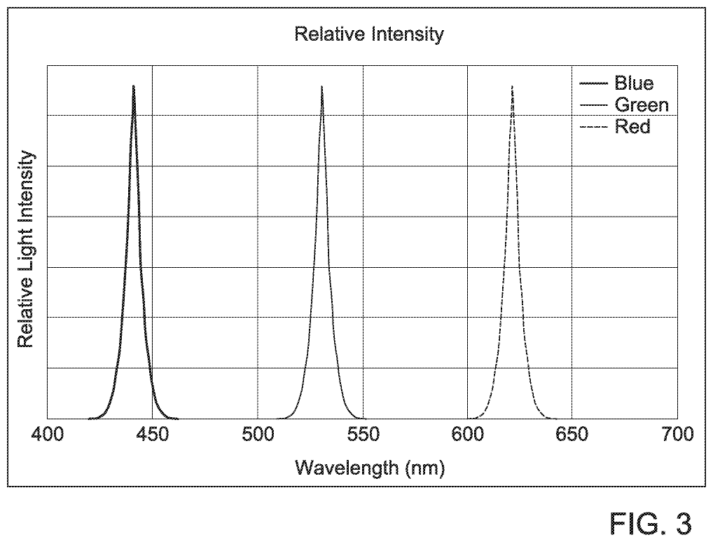

The disclosed multi-layer film may thus formalize the intensity from blue, red, and green colors. With proper optimization, the intensity from three colors may be high and may be close to one another in intensity value. Because the QDs in differing layers neither overlap, nor substantially overlap, relative light intensity peaks for red and green may be higher. FIG. 3 provides a rendering of relative light intensity peaks for red, green, and blue in use of the disclosed multi-layer film. Increased red and green intensity peaks may help to produce more saturated red and green which in turn may produce a larger color gamut and allow for a wider selection of color filters. With respect to overlap among QDs in layers of the multi-layer film, no overlap or substantially no overlap refers to overlap among the QDs in different layers being minimal. The amount of overlap may be measured and quantified by absorption and fluorescence quantum yield measurements.

The multi-layer film of the present disclosure may comprise quantum dot layers having QDs selectively disposed within multiple layers of the film. One or both of the plurality of first quantum dots and the plurality of second quantum dots may be disposed within a respective polymer matrix layer via processes known in the art. For example, and not to be limiting, QDs may be disposed within the layers via a printing process (such as 3-D printing), a lithography process, solution-cast process, an extrusion process (such as a melt extrusion process), or a polymerization process.

As provided herein, the QDs may be disposed in a QD layer. That is, the QDs may be disposed within a polymer matrix. In various aspects, the polymer matrix may be compatible with the QDs disposed therein. In further aspects, the polymer matrix may be configured or adjusted to improve compatibility between the polymer matrix and the QDs disposed therein. For example, the polymer matrix throughout which the QDs are disposed may be selected for having a particular refractive index. Additionally, the polymer matrix throughout which the QDs are disposed may be configured or adjusted to have a particular refractive index.

The polymer matrix of each layer may be tailored for the specific QDs embedded in that layer. For, example, additives with a gradient refractive index may be used in certain amounts in the polymer matrix to obtain refractive indices (RI) that are equal to or similar to the RI of quantum dots within the specific layer. Such refractive index matching may reduce the surface reflectance at the interface of the polymer matrix and the QDs. In certain aspects, the first polymer matrix may have a refractive index within 2 of that of the first quantum dots. In further aspects, the first polymer matrix may have a refractive index within about 1.5, within about 1, or within about 0.5 of that of the first quantum dots. The second polymer matrix may have a refractive index within 2 of that of the second quantum dots. In yet further aspects, the second polymer matrix may have a refractive index within about 1.5, within about 1, or within about 0.5 of that of the second quantum dots.

Referring again to FIG. 1, for example, the RI of the first polymer matrix 104 in the first quantum dot layer 102 may be tuned to be close (i.e., within 2) to that of the plurality of first quantum dots 106. Similarly, the RI of the second polymer matrix 110 may be close to that of the plurality of second quantum dots 112 in the second quantum dot layer 108. Customizing the polymer matrix with respect to the disposed quantum dots may provide more tailored performance enhancement. Specifically, the reduction of surface reflectance at the interface of polymer matrix and quantum dots helps to improve the light absorption and quantum yield.

In further examples, the composition of the polymer matrix may also be tailored to provide improved compatibility between the polymer matrix and the surface chemistry of modified quantum dots. Accordingly, layers of the multi-layer film may comprise a polymer matrix, a plurality of particular quantum dots, and, in some aspects, one or more compatibilizing additives. The additives may make the polymer matrix more compatible with the QD. In accordance with the above, the additives may comprise a refractive index modifying additive. In further examples, the first polymer matrix may be selected to be compatible to a ligand encapsulating the plurality of first quantum dots and the second polymer matrix may be selected to be compatible to a ligand encapsulating the plurality of second quantum dots.

A number of polymers may be useful as the polymer matrix of the present disclosure. In some aspects, one or both of the first polymer matrix and the second polymer matrix may include polycarbonate, acrylic (polymethylmethacrylate), polyimide, polyetherimide, polythiophene, epoxy, polyvinyl, poly-diacetylene, polyphenylene, polypeptide, polysaccharide, polysiloxane, polystyrene, polyethylene, polypropylene, polyacrylamide, polypyrrole, polyimidazole, polyphosphate poly(N-vinyl carbazole), polyethylene terephthalate, polybutylene terephthalate, polyurethane prepared from aliphatic and cycloaliphatic isocyanates, butyrate, (glycol modified polyethylene terephthalate), poly(maleic acid-alt-octadecene), ligand integrated polynorbornenes, polyamines, thiolated polyphenols, and functionalized ionic polymers, or poly(vinyl pyrrolidone) (PVP) or a combination thereof.

Suitable quantum dots 106, 112, 206, 212 for use in the multi-layer film described herein may include core-shell luminescent nanocrystals including cadmium sulfide CdS, cadmium selenide CdSe, cadmium telluride CdTe, zinc sulfide ZnS, zinc selenide ZnSe, zinc telluride ZnTe, zinc oxide ZnO, mercury sulfide HgS, mercury selenide HgSe, mercury telluride HgTe, gallium nitride GaN, gallium phosphide GaP, gallium arsenide GaAs, gallium antimonide GaSb, aluminum nitride AN, aluminum phosphide AlP, aluminum arsenide AlAs, aluminum antimonide AlSb, indium nitride InN, indium phosphide InP, indium arsenide InAs, indium antimonide InSb, tin(II) sulfide SnS, tin selenide SnSe, tin telluride SnTe, lead(II) sulfide PbS, lead selenide PbSe, lead telluride PbTe, silicon carbide SiC, silicon-germanium SiGe, alloys thereof, gradient alloys from core to shell thereof, and mixtures thereof. As an example, one or both of the first and second pluralities of quantum dots include cadmium sulfide. In a further example, one or both of the first and second pluralities of quantum dots comprise a core-shell structure. Exemplary shell material include, but are not limited to, ZnO, ZnS, ZnSe, ZnTe, CdO, CdS, CdSe, CdTe, MgS, MgSe, GaAs, GaN, GaP, GaAs, GaSb, HgO, HgS, HgSe, HgTe, InAs, InN, InP, InSb, AlAs, AlN, AlP, AlSb, or combinations thereof, optionally with the inner shell comprising at least one element selected from Group HB, Group IVA, Group VA, Group IHA, Group HA or Group VIA of the Periodic Table of Elements. In one aspect, the quantum dot has an inner core of CdSe and an outer shell of ZnS.

In various examples, at least a portion of the pluralities of quantum dots in a given layer of the present disclosure may be encapsulated in a medium, such as a polymer or a metal oxide medium. The encapsulant may provide additional protection to the quantum dots from air and moisture. In some examples, the encapsulant may also provide a gradient, or a gradual transition, from a quantum dot to the surrounding polymer matrix in terms of chemical composition or optical properties (such as, for example, refractive index). The disclosed quantum dots may be in an encapsulating material in the polymer matrix of the quantum dot layer. An encapsulating material or ligand may include a light transmissive organic material including, but not limited to, polymers such as polyethylene (PE), polypropylene (PP), polyethylene naphthalate (PEN), polycarbonate (PC), or polymethylacrylate (PMA), polymethylmethacrylate (PMMA), cellulose acetate butyrate (CAB) silicone—such as polymethylphenylsilicone, polyvinylchloride (PVC), polyvinyl alcohol (PVA), polyethylene terephthalate (PET), glycol modified polyethylene terephthalate, polydimethylsiloxane, or a cyclo-olefin copolymer. A light transmissive organic polymer may include a transparent polymer. In further examples, an inorganic material may comprise the encapsulant material. The inorganic material may include, but is not limited to glasses (having a low melting point), fused quartz, transmissive ceramic materials, and metal oxide materials (e.g., ZnO, aluminum oxide Al₂O₃, titanium oxide TiO₂, hafnium dioxide HfO₂, etc.).

Where the encapsulant materials comprise a polymer, the encapsulating polymer may be a different polymer than the polymer matrix within which the quantum dots are disposed. In other examples, the encapsulating polymer and the polymer matrix may comprise the same polymer, notwithstanding any additives present within the polymer matrix. Moreover, quantum dots in different quantum dot layers may be encapsulated by different encapsulant materials or polymers. For example, the plurality of first quantum dots comprising green phosphor with a peak emission wavelength between 490 nm and 580 nm (or about 490 nm to about 580 nm) may be encapsulated with a first encapsulant material and the plurality of second quantum dots comprising red phosphor with a peak emission wavelength between 600 nm and 750 nm (or about 600 nm to about 750 nm) may comprise a second encapsulant material. The first and second encapsulant materials may comprise different polymers.

The quantum dot layers described herein may have any useful amount of quantum dots. In some aspects the quantum dot layer may have from 0.001 wt. to 10 wt. % (or from about 0.001 wt. % to about 10 wt. %) quantum dots, or from 0.05 to 5 wt. % (or from about 0.05 to about 5 wt. %) quantum dots. It is understood that various intervening endpoints in the proposed size ranges may be used, such as 0.05 wt. % to 9 wt. %, 0.05 wt. % to 5 wt. %, 0.5 wt. % to 8 wt. %, 0.5 wt. % to 3 wt. %, 1 wt. % to 8 wt. %, 1 wt. % to 7 wt. %, 1 wt. % to 6 wt. %, 1 wt. % to 5 wt. %. However, other loadings of quantum dots 106, 112, 206, 212 may be used.

The quantum dot layer 208 may comprise scattering beads or particles. Scattering beads may change the light path and redirect it to quantum dots that may be obstructed in the optical path. Generally, scattering beads do not contribute to light absorption and fluorescence emission. Scattering beads, particularly if placed in the layer furthest away from the LED light source, may help to improve the uniformity of the transmitted blue light or the emitted red and green light. The inclusion of scattering particles may result in a longer optical path length and/or improved quantum dot absorption and efficiency in some aspects. In certain aspects the particle size is in a range from about 50 nm to about 10 micrometers (μm) or from 50 nm to 10 μm, or in particular aspects from about 100 nm to about 6 μm, or from 100 nm to 6 μm. It is understood that various intervening endpoints in the proposed size ranges may be used. The quantum dot layer 206 may further comprise fillers such as fumed silica or yet other additives in some aspects.

A quantum dot layer of the multi-layer film may have a particular thickness. The thickness of quantum dot layers may range from 10 micrometers (micron, μm) to 1000 μm, or from about 10 μm to about 1000 μm. For example, the quantum dot layer may have a thickness of 100 μm, or about 100 μm.

In various further aspects, the multi-layer film may comprise additional quantum dot layers. For example, the multi-layer may comprise a third or a fourth quantum dot layer. The third quantum dot layer is disposed adjacent the second quantum dot layer. The third quantum dot layer may comprise a third plurality of first portions and a third plurality of second portions. The third plurality of first portions may comprise a plurality of third quantum dots, while the third plurality of second portions comprises a third polymer matrix and is free of quantum dots.

As provided herein, the multi-layer film may comprise one or more barrier layers configured to enclose one or more of the first or second quantum dot layers, or additional quantum dot layers. The barrier layer(s) may be disposed adjacent a quantum dot layer to protect the quantum dot layer from oxygen and moisture.

As described herein, quantum dot layers of the multi-layer film may be adjacent one another, but not necessarily in contact with one another. That is, between the quantum dot layers may be an intervening layer. For example, an optically clear (transparent) adhesive layer and/or a refractive index matching layer disposed there between. In further examples, a protective layer may be disposed between layers.

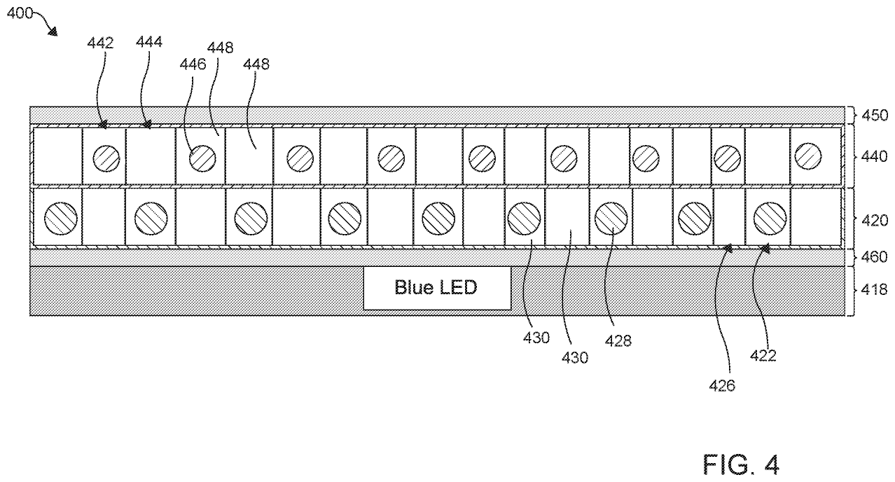

A multi-layer film of the present disclosure may comprise alternating portions having quantum dots selectively disposed within certain portions and excluded from other portions. For example, and referring now to FIG. 4, a multi-layer film 400 may comprise a first layer 420 comprising a set of first portions 422 and a set of second portions 426. The first layer 420 may be disposed adjacent a light source such as a blue LED source 418. However, other light sources may be used. The set of first portions 422 may have a plurality of first quantum dots 428 disposed within a polymer matrix 430, while the second portions 426 may comprise at least the polymer matrix 430 in the absence of the first quantum dots 428. The polymer matrix 430 may further comprise any suitable additive. The set of first portions 422 and the set of second portions 426 may be distributed throughout the first layer 420 in an alternating pattern, so as to create a pattern of a first portion 422, a second portion 426, a first portion 422, a second portion 426, and so on and so forth.

A second layer 440 may be disposed adjacent the first layer 420. The second layer 440 may comprise a second set of first portions 442 and a second set of second portions 444. The second set of first portions 442 may have a second quantum dot 446 disposed within a second polymer matrix 448. The second set of second portions 444 may comprise at least the second polymer matrix 448 in the absence of any of the first or second quantum dots 428, 446. The second set of first portions 442 and the second set of second portions 444 may be distributed throughout the second layer 440 in an alternating pattern, so as to create a pattern of a first portion 442, a second portion 444, a first portion 442, a second portion 444, and so on and so forth. However, orientation of the portions 422, 426, 442, 444 in the multi-layer film 400 may be such that the first set of first portions 422 aligns with the second set of second portions 444 and the first set of second portions 426 aligns with the second set of first portions 442. In such a configuration, portions comprising quantum dots (i.e., first set of first portions 422, second set of first portions 442) exhibit no overlap or minimal overlap along an orthogonal axis. Portions comprising quantum dots instead may overlap portions comprising at least the polymer matrix in the absence of a quantum dot. Avoiding orthogonal overlap among portions having quantum dots may allow quantum dots in the layers to receive unobstructed (or substantially unobstructed) light energy from the light source. In other words, the quantum dots may be in the light path of the light source so that they may absorb light energy and emit the secondary light, thereby supporting the conversion efficiency of the multi-layer film.

The (first) polymer matrix 430 may be configured to have a refractive index that is within 2 of the first quantum dots 428, while the second polymer matrix 448 may have a refractive index within 2 of the refractive index of the second quantum dots 446. The similarity in refractive index among the quantum dots 428, 446 and the polymer matrices 428, 430 reduces the occurrence of light reflectance in the multi-layer film at interfaces between the quantum dots 428, 446 and the polymer matrices 428, 430. Reduced light reflectance in the layers of the multi-layer film may keep the light path from the light source to the quantum dots intact. The absence of overlap (or minimal overlap) among portions comprising quantum dots and the refractive index matching between the polymer matrix and quantum dots in those portions having quantum dots also cooperate to optimize the conversion efficiency of the multi-layer film 400.

With reference to FIGS. 1 and 4, the multi-layer film may comprise one or more quantum dot layers 102, 108, 420, 440 disposed between first and second barrier films or layers 114, 116, 450, 460. The barrier films 114, 116, 450, 460 inhibit oxygen and/or moisture from reacting with the quantum dot layers 102, 108, 440, 420 by providing a physical barrier. However, the barrier layers or films may be relatively thick and may thus greatly contribute to the overall thickness of the quantum dot film. In certain aspects, the barrier films may make up two thirds or more of the total film thickness without additional functional layers. Also, they are relatively expensive to produce. In accordance with the disclosure herein, at least one of the first and second barrier films in the conventional quantum dot film may be replaced with a protective layer. The protective layer may comprise one or more layers. In one example, the protective layer comprises a barrier polymer and a scavenger. In a further example, the protective layer may comprise a functional layer such as a diffuser layer or a prism disposed thereon. As a further example, the protective layer may comprise an inorganic layer or a hybrid layer. The protective layer of the disclosure is thinner than the barrier layer, reducing the overall thickness of multi-layer film. It may also reduce the cost of producing the multi-layer film in some aspects. In some examples, the thickness of each barrier layer may range from about 5 μm to about 500 μm. In one example, the barrier layer may have a thickness of about 50 μm.

The barrier layer may comprise any useful material that may protect the quantum dots from environmental conditions such as oxygen and moisture. Suitable barrier films may include, e.g., polymers, glass or dielectric materials. Suitable barrier film materials include, but are not limited to: polymers such as polyethylene terephthalate (PET); oxides such as silicon oxide, titanium oxide, or aluminum oxide (e.g., SiO₂, Si₂O₃, TiO₂, or Al₂O₃); and suitable combinations thereof. The barrier layer of the multi-layer film may include at least two layers of different materials or compositions, such that the multi-layered barrier eliminates or reduces pinhole defect alignment in the barrier layer, providing an effective barrier to oxygen and moisture penetration into the quantum dot layers.

In addition, the material comprising the barrier layer may include organic and inorganic hybrid materials. For example, the barrier layer may include a material represented by the following structure, where R1 is an organic component offering flexibility and R2 is an organic component that improves adhesion.

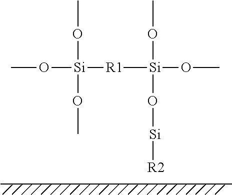

The scavenger, which may be present in a protective layer for example, may comprise any compound that absorbs at least one of oxygen and moisture. For example, the scavenger may comprise a phenolic acid. Phenolic acids are types of aromatic acid compounds. Included in that class are substances containing a phenolic ring and an organic carboxylic acid function (C6-C1 skeleton). Phenolic acids generally act as antioxidants by trapping free radicals. Phenolic acids may react with oxygen and/or moisture in the protecting layer. Phenolic acids may prevent permeation of at least one of oxygen and moisture from the external atmosphere into the quantum dot layer. There are several categories of phenolic acids including:

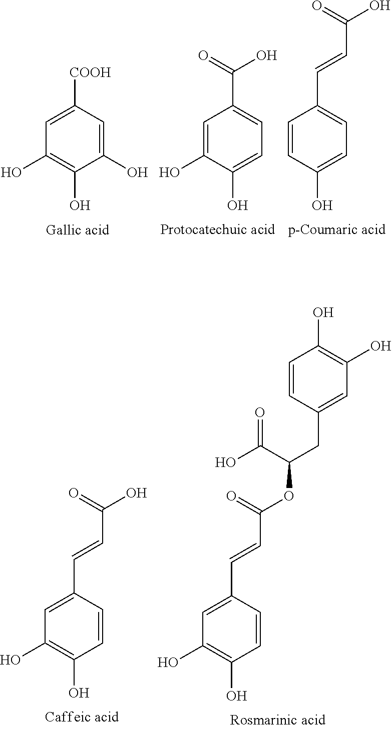

Optionally, a protective layer may comprise a functional layer. For example, the functional layer may be or comprise a diffuser layer. In another example, the functional layer may be a prism to enhance brightness of the underlying film. Other functional or ornamental layers may be used, such as, a surface matte treatment and/or a scratch resistant treatment as desired for a given application of the multi-layer film.

The protecting layer may be formed by, e.g., a low temperature wet process. As an example, the protective layer may comprise a flowable curable coating composition as described herein. As such, the flowable curable coating composition may be used to coat a surface such as a quantum dot layer of a film. As an example, a low temperature wet process may comprise a coating method including but not limited to roll coating, gravure coating, knife coating, dip coating, curtain flow coating, spray coating, bar coating, die coating, spin coating, or inkjet coating and the like. Once cured, the protective layer(s) may have a thickness that is less than the thickness of the barrier layer in some aspects. As an example, the barrier layer may have a thickness of 100 microns, or about 100 microns, and the protective layer may have a thickness of less than 100 microns. In another example, the protective layer may have a thickness of less than 50 microns. Since the protective layer may have a thickness that is less than the barrier layer, the overall thickness of the stack of layers may be minimized compared to a stack having two of the barrier layers.

Once the protective layer is applied to the quantum dot layer, the protective layer may be separately cured according to curing methods appropriate for the material including but not limited to ultraviolet (UV) curing.

The multi-layer film may comprise any suitable material or combination of materials. In some examples, only one barrier layer may be provided, however, additional barrier layers may be added outward of the structures shown in the figures if desired for a particular multi-layer film application.

In one or more aspects, the multi-layer film comprises an optical construction. The optical construction may comprise a blue LED light source emitting blue light having a wavelength in a range from 440 nm to 460 nm and a Full Width, Half Max (FWHM) of less than 25 nm, an LCD panel having a native color gamut in a range from 35% to 45% NTSC, and one or more QD layers (as described herein) positioned or optically between the blue light source and the LCD panel. The optical construction may achieve a color gamut of at least 50% NTSC in some aspects.

### Methods of Making

Aspects of the disclosure further relate to multi-layer films and methods of making a multi-layer film. In various aspects, a method of making a multi-layer film may comprise coating a first QD layer comprising a plurality of first quantum dots on a protective or barrier layer and disposing a second layer comprising a plurality of second quantum dots on the first layer. For example, QDs may be disposed within the layers via a printing process (such as 3-D printing), a lithography process, a solution-cast process, an extrusion process (such as melt extrusion), or a polymerization process. However, other process may be used. A barrier or protective layer maybe applied by means of roll coating, gravure coating, knife coating, dip coating, curtain flow coating, spray coating, bar coating, die coating, spin coating or inkjet coating, by using a dispenser, or other means.

The barrier or protective solution may be cured to form a protective layer adhered to the quantum dot layer(s). The protective solution may be cured using one or more of a radiation curing process, including but not limited to, an ultraviolet (UV) curing process; and, a thermal curing process including, but not limited to, a steam curing process. The protective layer inhibits the permeation of at least oxygen and moisture into the quantum dot layer. The protective layer may optionally comprise a functional layer disposed adjacent an inorganic layer. The inorganic layer of the protective layer may include a polysilazane-based polymer, a polysiloxane-based polymer, or a combination thereof. As a further option, the protective layer may comprise, consist essentially of, or consist of a functional layer disposed adjacent a hybrid layer. The hybrid layer of the protective layer may comprise an organic component and an inorganic component.

A solution coating may be applied to the barrier film or protective layer, typically acrylic material with UV curing. In some examples, a polymer based barrier or protective film may be coated with an inorganic layer (e.g., aluminum oxide, Al₂O₃) via atomic deposition technology or physical vapor deposition, for example.

The method may comprise coating a surface of a substrate, such as a solid plastic form, with a flowable curable coating composition. The coating may be performed in any suitable manner that forms a coating of the flowable curable coating composition on a surface of the solid plastic form. Wet or transfer coating methods may be used. For example, the coating may be bar coating, spin coating, spray coating, or dipping. Single- or multiple-side coatings may be performed.

The substrate may be transparent, opaque, or any one or more colors. The solid plastic form may include any one or more suitable plastics (e.g., as a homogeneous mixture of plastics). In some aspects, the substrate may include at least one of an acrylonitrile butadiene styrene (ABS) polymer, an acrylic polymer, a celluloid polymer, a cellulose acetate polymer, a cycloolefin copolymer (COC), an ethylene-vinyl acetate (EVA) polymer, an ethylene vinyl alcohol (EVOH) polymer, a fluoroplastic, an ionomer, an acrylic/PVC alloy, a liquid crystal polymer (LCP), a polyacetal polymer (POM or acetal), a polyacrylate polymer, a polymethylmethacrylate polymer (PMMA), a polyacrylonitrile polymer (PAN or acrylonitrile), a polyamide polymer (PA or nylon), a polyamide-imide polymer (PAI), a polyaryletherketone polymer (PAEK), a polybutadiene polymer (PBD), a polybutylene polymer (PB), a polybutylene terephthalate polymer (PBT), a polycaprolactone polymer (PCL), a polychlorotrifluoroethylene polymer (PCTFE), a polytetrafluoroethylene polymer (PTFE), a polyethylene terephthalate polymer (PET), a polycyclohexylene dimethylene terephthalate polymer (PCT), a polycarbonate polymer (PC), a polyhydroxyalkanoate polymer (PHA), a polyketone polymer (PK), a polyester polymer, a polyethylene polymer (PE), a polyetheretherketone polymer (PEEK), a polyetherketoneketone polymer (PEKK), a polyetherketone polymer (PEK), a polyetherimide polymer (PEI), a polyethersulfone polymer (PES), a polyethylenechlorinate polymer (PEC), a polyimide polymer (PI), a polylactic acid polymer (PLA), a polymethylpentene polymer (PMP), a polyphenylene oxide polymer (PPO), a polyphenylene sulfide polymer (PPS), a polyphthalamide polymer (PPA), a polypropylene polymer, a polystyrene polymer (PS), a polysulfone polymer (PSU), a polytrimethylene terephthalate polymer (PTT), a polyurethane polymer (PU), a polyvinyl acetate polymer (PVA), a polyvinyl chloride polymer (PVC), a polyvinylidene chloride polymer (PVDC), a polyamideimide polymer (PAI), a polyarylate polymer, a polyoxymethylene polymer (POM), and a styrene-acrylonitrile polymer (SAN). In some aspects, the solid plastic form includes at least one of polycarbonate polymer (PC), polymethylmethacrylate polymer (PMMA), or a blend thereof.

The substrate may comprise one or more polycarbonate or multiple types of polycarbonate. The polycarbonate may be made via interfacial polymerization (e.g., reaction of bisphenol with phosgene at an interface between an organic solution such as methylene chloride and a caustic aqueous solution) or melt polymerization (e.g., transesterification and/or polycondensation of monomers or oligomers above the melt temperature of the reaction mass).

The substrate may comprise a filler, such as one filler or multiple fillers. The filler may be any suitable type of filler. The filler may be homogeneously distributed in the solid plastic form. The one or more fillers may form 0.001 wt. % to 50 wt. % (or from about 0.001 wt. % to about 50 wt. %) of the solid plastic form, or 0.01 wt. % to 30 wt. % (or from about 0.01 wt. % to about 30 wt. %), or 0.001 wt. % or about 0.001 wt. % or less, or about 0.01 wt. %, 0.1, 1, 2, 3, 4, 5, 10, 15, 20, 25, 30, 35, 40, 45 wt. %, or about 50 wt. % or more. The filler may be fibrous or particulate. The filler may include, but is not limited to: aluminum silicate (mullite); synthetic calcium silicate; zirconium silicate; fused silica; crystalline silica graphite; natural silica sand or the like; boron powders; oxides such as TiO₂, aluminum oxide, magnesium oxide, or the like; calcium sulfate (as its anhydride, dehydrate or trihydrate); calcium carbonates such as chalk, limestone, marble, synthetic precipitated calcium carbonates, or the like; talc, including fibrous, modular, needle shaped, lamellar talc, or the like; wollastonite; surface-treated wollastonite; glass spheres such as hollow and solid glass spheres; kaolin; single crystal fibers or “whiskers” such as silicon carbide, alumina, boron carbide, iron, nickel, copper, or the like; fibers (including continuous and chopped fibers) such as asbestos, carbon fibers, glass fibers; sulfides such as molybdenum sulfide, zinc sulfide, or the like; barium compounds; metals and metal oxides such as particulate or fibrous materials; flaked fillers; fibrous fillers, for example short inorganic fibers such as those derived from blends including at least one of aluminum silicates, aluminum oxides, magnesium oxides, and calcium sulfate hemihydrate or the like; natural fillers and reinforcements; organic fillers such as polytetrafluoroethylene, reinforcing organic fibrous fillers formed from organic polymers capable of forming fibers such as poly(ether ketone), polyimide, polybenzoxazole, poly(phenylene sulfide), polyesters, polyethylene, aromatic polyamides, aromatic polyimides, polyetherimides, polytetrafluoroethylene, acrylic resins, poly(vinyl alcohol) or the like; or combinations including at least one of the foregoing fillers. In particular aspects, the filler is selected from glass fibers, carbon fibers, a mineral fillers, or combinations thereof. In a specific aspect the filler includes glass fibers.

The substrate may comprise a polyester. The polyester may be any suitable polyester. The polyester may be chosen from aromatic polyesters, poly(alkylene esters) including poly(alkylene arylates) (e.g., poly(alkylene terephthalates)), and poly(cycloalkylene diesters) (e.g., poly(cyclohexanedimethylene terephthalate) (PCT), or poly(1,4-cyclohexane-dimethanol-1,4-cyclohexanedicarboxylate) (PCCD)), and resorcinol-based aryl polyesters. The polyester may be poly(isophthalate-terephthalate-resorcinol)esters, poly(isophthalate-terephthalate-bisphenol A)esters, poly[(isophthalate-terephthalate-resorcinol)ester-co-(isophthalate-terephthalate-bisphenol A)]ester, or a combination including at least one of these. Examples of poly(alkylene terephthalates) comprise poly(ethylene terephthalate) (PET), poly(1,4-butylene terephthalate) (PBT), and poly(propylene terephthalate) (PPT). Also useful are poly(alkylene naphthoates), such as poly(ethylene naphthanoate) (PEN), and poly(butylene naphthanoate) (PBN). Copolymers including alkylene terephthalate repeating ester units with other ester groups may also be useful. Useful ester units may comprise different alkylene terephthalate units, which may be present in the polymer chain as individual units, or as blocks of poly(alkylene terephthalates). Specific examples of such copolymers comprise poly(cyclohexanedimethylene terephthalate)-co-poly(ethylene terephthalate), abbreviated as PETG where the polymer comprises greater than or equal to 50 mol % of poly(ethylene terephthalate), and abbreviated as PCTG where the polymer comprises greater than 50 mol % of poly(1,4-cyclohexanedimethylene terephthalate). The polyester may be substantially homogeneously distributed in the solid plastic form. The solid plastic form may comprise one type of polyester or multiple types of polyester. The one or more polyesters may form any suitable proportion of the solid plastic form, such as 0.001 wt. % to 50 wt. % or about 0.001 wt. % to about 50 wt. % of the solid plastic form, 0.01 wt. % to 30 wt. % or about 0.01 wt. % to about 30 wt. %, or about 0.001 wt. % or less, or about 0.01 wt. %, 0.1, 1, 2, 3, 4, 5, 6, 8, 10, 12, 14, 16, 18, 20, 22, 24, 26, 28, 30, 35, 40, 45 wt. %, or about 50 wt. % or more. The polyester may comprises a repeating unit having the structure:

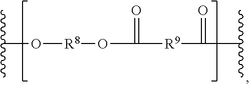

The variables R⁸ and R⁹ may be independently substituted or unsubstituted (C₁-C₂₀)hydrocarbylene. The variables R⁸ and R⁹ may be cycloalkylene-containing groups or aryl-containing groups. The variables R⁸ and R⁹ may be independently substituted or unsubstituted phenyl, or substituted or unsubstituted —(C₀-C₁₀)hydrocarbyl-(C₄-C₁₀)cycloalkyl-(C₀-C₁₀)hydrocarbyl-. The variables R⁸ and R⁹ may both be cycloalkylene-containing groups. The variables R⁸ and R⁹ may independently have the structure:

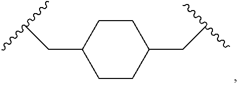 [SMILES: *CC1CCC(C*)CC1]

wherein the cyclohexylene can be substituted in a cis or trans fashion. In some examples, R9 may be a para-substituted phenyl, such that R⁹ appears in the polyester structure as:

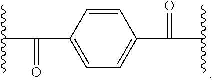 [SMILES: *C(=O)c1ccc(C(*)=O)cc1]

The substrate may have any suitable shape and size. In some aspects, the substrate is a sheet having any suitable thickness, such as a thickness of 25 microns to 50,000 microns or about 25 microns to about 50,000 microns, 25 microns to 15,000 microns or about 25 microns to about 15,000 microns, 60 microns to 800 microns or about 60 microns to about 800 microns, or 25 microns or less, or about 25 microns or less, or about 50, 75, 100, 150, 200, 250, 300, 400, 500, 600, 700, 800, 900, 1,000, 1,500, 2,000, 3,000, 4,000, 5,000, 6,000, 8,000, 10,000, 12,000, 14,000, 15,000, 20,000, 25,000, 30,000, 40,000, or about 50,000 microns or more.

The present disclosure relates to at least the following aspects.

Aspect 1A. A multi-layer film comprising: a first quantum dot layer comprising a first polymer matrix and a plurality of first quantum dots disposed in the first polymer matrix, wherein the plurality of first quantum dots are spaced from each other within the first polymer matrix to define gaps there between and the plurality of first quantum dots emit first secondary light upon excitation by light produced from a light source; and a second quantum dot layer disposed adjacent the first quantum dot layer, the second quantum dot layer comprising a second polymer matrix and a plurality of second quantum dots disposed in the second polymer matrix such that at least a portion of the plurality of second quantum dots align with the gaps defined in the first polymer matrix along an axis that is orthogonal to the first quantum dot layer and the second quantum dot layer, and the plurality of second quantum dots emit second secondary light upon excitation by light produced from the light source; wherein a peak wavelength of the first secondary light is higher than a peak wavelength of the second secondary light and the first quantum dot layer is placed in closer adjacency to the light source than the second quantum dot layer, the plurality of second quantum dots do not substantially overlap the plurality of first quantum dots along an axis orthogonal to the first quantum dot layer and the second quantum dot layer, the plurality of first quantum dots are spaced at a minimum of one radius of a first quantum dot and the plurality of second quantum dots are spaced at a minimum of one radius of a second quantum dot, and the first polymer matrix has a refractive index within 2 of the first quantum dots and the second polymer matrix has a refractive index within 2 of the second quantum dots.

Aspect 1B. A multi-layer film consisting essentially of: a first quantum dot layer comprising a first polymer matrix and a plurality of first quantum dots disposed in the first polymer matrix, wherein the plurality of first quantum dots are spaced from each other within the first polymer matrix to define gaps there between and the plurality of first quantum dots emit first secondary light upon excitation by light produced from a light source; and a second quantum dot layer disposed adjacent the first quantum dot layer, the second quantum dot layer comprising a second polymer matrix and a plurality of second quantum dots disposed in the second polymer matrix such that at least a portion of the plurality of second quantum dots align with the gaps defined in the first polymer matrix along an axis that is orthogonal to the first quantum dot layer and the second quantum dot layer, and the plurality of second quantum dots emit second secondary light upon excitation by light produced from the light source; wherein a peak wavelength of the first secondary light is higher than a peak wavelength of the second secondary light and the first quantum dot layer is placed in closer adjacency to the light source than the second quantum dot layer, the plurality of second quantum dots do not substantially overlap the plurality of first quantum dots along an axis orthogonal to the first quantum dot layer and the second quantum dot layer, the plurality of first quantum dots are spaced at a minimum of one radius of a first quantum dot and the plurality of second quantum dots are spaced at a minimum of one radius of a second quantum dot, and the first polymer matrix has a refractive index within 2 of the first quantum dots and the second polymer matrix has a refractive index within 2 of the second quantum dots.

Aspect 1C. A multi-layer film consisting of: a first quantum dot layer comprising a first polymer matrix and a plurality of first quantum dots disposed in the first polymer matrix, wherein the plurality of first quantum dots are spaced from each other within the first polymer matrix to define gaps there between and the plurality of first quantum dots emit first secondary light upon excitation by light produced from a light source; and a second quantum dot layer disposed adjacent the first quantum dot layer, the second quantum dot layer comprising a second polymer matrix and a plurality of second quantum dots disposed in the second polymer matrix such that at least a portion of the plurality of second quantum dots align with the gaps defined in the first polymer matrix along an axis that is orthogonal to the first quantum dot layer and the second quantum dot layer, and the plurality of second quantum dots emit second secondary light upon excitation by light produced from the light source; wherein a peak wavelength of the first secondary light is higher than a peak wavelength of the second secondary light and the first quantum dot layer is placed in closer adjacency to the light source than the second quantum dot layer, the plurality of second quantum dots do not substantially overlap the plurality of first quantum dots along an axis orthogonal to the first quantum dot layer and the second quantum dot layer, the plurality of first quantum dots are spaced at a minimum of one radius of a first quantum dot and the plurality of second quantum dots are spaced at a minimum of one radius of a second quantum dot, and the first polymer matrix has a refractive index within 2 of the first quantum dots and the second polymer matrix has a refractive index within 2 of the second quantum dots.

Aspect 2A. A multi-layer film comprising: a first quantum dot layer comprising a first polymer matrix and a plurality of first quantum dots disposed in the first polymer matrix, wherein the plurality of first quantum dots are spaced from each other within the first polymer matrix to define gaps there between and the plurality of first quantum dots emit first secondary light upon excitation by light produced from a light source; and a second quantum dot layer disposed adjacent the first quantum dot layer, the second quantum dot layer comprising a second polymer matrix and a plurality of second quantum dots disposed in the second polymer matrix such that at least a portion of the plurality of second quantum dots align with the gaps defined in the first polymer matrix along an axis that is orthogonal to the first quantum dot layer and the second quantum dot layer, and the plurality of second quantum dots emit second secondary light upon excitation by light produced from the light source; wherein a peak wavelength of the first secondary light is higher than a peak wavelength of the second secondary light and the first quantum dot layer is placed in closer adjacency to the light source than the second quantum dot layer, the plurality of second quantum dots do not substantially overlap the plurality of first quantum dots along an axis orthogonal to the first quantum dot layer and the second quantum dot layer, the plurality of first quantum dots are spaced at a minimum of one radius of a first quantum dot and the plurality of second quantum dots are spaced at a minimum of one radius of a second quantum dot, and the first polymer matrix has a refractive index within about 2 of the first quantum dots and the second polymer matrix has a refractive index within about 2 of the second quantum dots.

Aspect 2B. A multi-layer film consisting of: a first quantum dot layer comprising a first polymer matrix and a plurality of first quantum dots disposed in the first polymer matrix, wherein the plurality of first quantum dots are spaced from each other within the first polymer matrix to define gaps there between and the plurality of first quantum dots emit first secondary light upon excitation by light produced from a light source; and a second quantum dot layer disposed adjacent the first quantum dot layer, the second quantum dot layer comprising a second polymer matrix and a plurality of second quantum dots disposed in the second polymer matrix such that at least a portion of the plurality of second quantum dots align with the gaps defined in the first polymer matrix along an axis that is orthogonal to the first quantum dot layer and the second quantum dot layer, and the plurality of second quantum dots emit second secondary light upon excitation by light produced from the light source; wherein a peak wavelength of the first secondary light is higher than a peak wavelength of the second secondary light and the first quantum dot layer is placed in closer adjacency to the light source than the second quantum dot layer, the plurality of second quantum dots do not substantially overlap the plurality of first quantum dots along an axis orthogonal to the first quantum dot layer and the second quantum dot layer, the plurality of first quantum dots are spaced at a minimum of one radius of a first quantum dot and the plurality of second quantum dots are spaced at a minimum of one radius of a second quantum dot, and the first polymer matrix has a refractive index within about 2 of the first quantum dots and the second polymer matrix has a refractive index within about 2 of the second quantum dots.

Aspect 2C. A multi-layer film consisting essentially of: a first quantum dot layer comprising a first polymer matrix and a plurality of first quantum dots disposed in the first polymer matrix, wherein the plurality of first quantum dots are spaced from each other within the first polymer matrix to define gaps there between and the plurality of first quantum dots emit first secondary light upon excitation by light produced from a light source; and a second quantum dot layer disposed adjacent the first quantum dot layer, the second quantum dot layer comprising a second polymer matrix and a plurality of second quantum dots disposed in the second polymer matrix such that at least a portion of the plurality of second quantum dots align with the gaps defined in the first polymer matrix along an axis that is orthogonal to the first quantum dot layer and the second quantum dot layer, and the plurality of second quantum dots emit second secondary light upon excitation by light produced from the light source; wherein a peak wavelength of the first secondary light is higher than a peak wavelength of the second secondary light and the first quantum dot layer is placed in closer adjacency to the light source than the second quantum dot layer, the plurality of second quantum dots do not substantially overlap the plurality of first quantum dots along an axis orthogonal to the first quantum dot layer and the second quantum dot layer, the plurality of first quantum dots are spaced at a minimum of one radius of a first quantum dot and the plurality of second quantum dots are spaced at a minimum of one radius of a second quantum dot, and the first polymer matrix has a refractive index within about 2 of the first quantum dots and the second polymer matrix has a refractive index within about 2 of the second quantum dots.

Aspect 3. The multi-layer film of any one of aspects 1A-2C, wherein the first quantum dot layer is disposed adjacent a blue light emitting source and the first quantum dot layer is closer in distance to the blue light emitting source than the second quantum dot layer.

Aspect 4. The multi-layer film of any one of aspects 1A-3, wherein the first polymer matrix has a refractive index within 0.5 of the first quantum dots and the second polymer matrix has a refractive index within 0.5 of the second quantum dots.

Aspect 5. The multi-layer film of any one of aspects 1A-3, wherein the first polymer matrix has a refractive index within about 0.5 of the first quantum dots and the second polymer matrix has a refractive index about within 0.5 of the second quantum dots.

Aspect 6. The multi-layer film of any one of aspects 1A-3, wherein the first polymer matrix has a refractive index within about 0.5 of the first quantum dots.

Aspect 7. The multi-layer film of any one of aspects 1A-3, wherein the second polymer matrix has a refractive index about within 0.5 of the second quantum dots.

Aspect 8. The multi-layer film of any one of aspects 1A-7, further comprising at least a third quantum dot layer, wherein the third quantum dot layer is disposed adjacent the second quantum dot layer, the third quantum dot layer comprises a plurality of at least third quantum dots that emit at least third secondary light upon excitation of light produced by the light source, and a peak wavelength of the third secondary light in the third quantum dot layer is lower than the peak wavelength of secondary light in an adjacent layer that is closer to the light source.

Aspect 9. The multi-layer film of any one of aspects 1A-8, wherein at least a portion of the plurality of first quantum dots is larger than at least a portion of the plurality of second quantum dots.

Aspect 10. The multi-layer film of any one of aspects 1A-9, wherein the plurality of first quantum dots comprises quantum dots have a size from about 3 nanometers (nm) to about 11 nm.

Aspect 11. The multi-layer film of any one of aspects 1A-10, wherein the first plurality of quantum dots comprise red phosphor with a peak emission wavelength between about 600 nm to about 750 nm.

Aspect 12. The multi-layer film of any one of aspects 1A-10, wherein the first plurality of quantum dots comprise red phosphor with a peak emission wavelength between 600 nm to 750 nm.

Aspect 13. The multi-layer film of any one of aspects 1A-12, wherein the second plurality of quantum dots comprise quantum dots sized from about 1 nm to about 8 nm.

Aspect 14. The multi-layer film of any one of aspects 1A-12, wherein the second plurality of quantum dots comprise quantum dots sized from 1 nm to 8 nm.

Aspect 15. The multi-layer film of any one of aspects 1A-14, wherein the second plurality of quantum dots comprise green phosphor with a peak emission wavelength between about 490 nm to about 580 nm.

Aspect 16. The multi-layer film of any one of aspects 1A-14, wherein the second plurality of quantum dots comprise green phosphor with a peak emission wavelength between 490 nm to 580 nm.

Aspect 17. The multi-layer film of any one of aspects 1A-16, wherein one or both of the plurality of first quantum dots and the plurality of second quantum dots are disposed in their respective quantum dot layer by way of a printing process, an extrusion process or melt extrusion process, a solution-cast process, a lithography process or a polymerization process.

Aspect 18. The multi-layer film of any one of aspects 1A-17, further comprising one or more barrier layers that enclose one or more of the first quantum dot layer or the second quantum dot layer.

Aspect 19. The multi-layer film of any one of aspects 1A-18, wherein one or both of the first polymer matrix or the second polymer matrix comprises polycarbonate, acrylic (polymethylmethacrylate), polyimide, polyetherimide, polythiophene, epoxy, polyvinyl, poly-diacetylene, polyphenylene, polypeptide, polysaccharide, polysiloxane, polystyrene, polyethylene, polypropylene, polyacrylamide, polypyrrole, polyimidazole, polyphosphate poly(N-vinyl carbazole), polyethylene terephthalate, polybutylene terephthalate, polyurethane prepared from aliphatic and cycloaliphatic isocyanates, butyrate, (glycol modified polyethylene terephthalate), poly(maleic acid-alt-octadecene), ligand integrated polynorbornenes, polyamines, thiolated polyphenols, and functionalized ionic polymers, or poly(vinyl pyrrolidone) or a combination thereof.

Aspect 20. The multi-layer film of any one of aspects 1-19, wherein one or both of the plurality of first quantum dots and the plurality of second quantum dots comprise CdS, CdSe, CdTe, ZnS, ZnSe, ZnTe, ZnO, HgS, HgSe, HgTe, GaN, GaP, GaAs, GaSb, AlP, AlAs, AlSb, InN, InP, InAs, InSb, SnS, SnSe, SnTe, PbS, PbSe, PbTe, SiC, SiGe, GaAs, GaP, GaAs, GaSb, HgS, HgSe, HgTe, InAs, InP, InSb, AlAs, alloys thereof, and mixtures thereof.

Aspect 21. The multi-layer film of any one of aspects 1-20, wherein one or both of the plurality of first quantum dots and the plurality of second quantum dots comprise a core-shell structure.

Aspect 22. The multi-layer film of any one of aspects 1-21, wherein one or both of the first polymer matrix and the second polymer matrix further comprise a refractive index-modifying additive.

Aspect 23. The multi-layer film of any one of aspects 1-22, wherein the first polymer matrix is selected to be compatible to a ligand encapsulating the first quantum dots.

Aspect 24. The multi-layer film of any one of aspects 1-23, wherein the second polymer matrix is selected to be compatible to a ligand encapsulating the second quantum dots.

Aspect 25. The multi-layer film of any one of claims 1-24, wherein the plurality of first quantum dots comprises a first encapsulant material and the plurality of second quantum dots comprises a second encapsulant material, wherein the first and second encapsulant materials comprise different polymers

Aspect 26. An article including the multi-layer film of any one of aspects 1-25.

Aspect 27. A method of forming a multi-layer film according to any one of aspects 1-26.

Aspect 28A. A multi-layer film comprising: a first quantum dot layer comprising a first polymer matrix and a plurality of first quantum dots disposed in the first polymer matrix, wherein the plurality of first quantum dots are spaced from each other within the first polymer matrix to define gaps there between; and a second quantum dot layer disposed adjacent the first quantum dot layer, the second quantum dot layer comprising a second polymer matrix and a plurality of second quantum dots disposed in the second polymer matrix such that at least a portion of the plurality of second quantum dots align with the gaps defined in the first polymer matrix along an axis that is orthogonal to the first quantum dot layer and the second quantum dot layer, wherein the plurality of first quantum dots are spaced at a minimum of one radius of a first quantum dot and the plurality of second quantum dots are spaced at a minimum of one radius of a second quantum dot, and the first polymer matrix has a refractive index within 2 of the first quantum dots and the second polymer matrix has a refractive index within 2 of the second quantum dots.

Aspect 28B. A multi-layer film consisting essentially of: a first quantum dot layer comprising a first polymer matrix and a plurality of first quantum dots disposed in the first polymer matrix, wherein the plurality of first quantum dots are spaced from each other within the first polymer matrix to define gaps there between; and a second quantum dot layer disposed adjacent the first quantum dot layer, the second quantum dot layer comprising a second polymer matrix and a plurality of second quantum dots disposed in the second polymer matrix such that at least a portion of the plurality of second quantum dots align with the gaps defined in the first polymer matrix along an axis that is orthogonal to the first quantum dot layer and the second quantum dot layer, wherein the plurality of first quantum dots are spaced at a minimum of one radius of a first quantum dot and the plurality of second quantum dots are spaced at a minimum of one radius of a second quantum dot, and the first polymer matrix has a refractive index within 2 of the first quantum dots and the second polymer matrix has a refractive index within 2 of the second quantum dots.

Aspect 28C. A multi-layer film consisting of: a first quantum dot layer comprising a first polymer matrix and a plurality of first quantum dots disposed in the first polymer matrix, wherein the plurality of first quantum dots are spaced from each other within the first polymer matrix to define gaps there between; and a second quantum dot layer disposed adjacent the first quantum dot layer, the second quantum dot layer comprising a second polymer matrix and a plurality of second quantum dots disposed in the second polymer matrix such that at least a portion of the plurality of second quantum dots align with the gaps defined in the first polymer matrix along an axis that is orthogonal to the first quantum dot layer and the second quantum dot layer, wherein the plurality of first quantum dots are spaced at a minimum of one radius of a first quantum dot and the plurality of second quantum dots are spaced at a minimum of one radius of a second quantum dot, and the first polymer matrix has a refractive index within 2 of the first quantum dots and the second polymer matrix has a refractive index within 2 of the second quantum dots.

Aspect 29A. A multi-layer film comprising: a first quantum dot layer comprising a first plurality of first portions and a first plurality of second portions, the first portions comprising a plurality of first quantum dots and the second portions consisting essentially of a first polymer matrix and one or more additives, wherein the plurality of first portions and the plurality of second portions are disposed in an alternating pattern; and a second quantum dot layer disposed adjacent the first quantum dot layer, the second quantum dot layer comprising a second plurality of first portions and a second plurality of second portions, wherein the second plurality of first portions comprises a plurality of second quantum dots and wherein the second plurality of second portions consisting essentially of a second polymer matrix or consisting essentially of a second polymer matrix and one or more additives, wherein the second plurality of first portions and second plurality of second portions are disposed in an alternating pattern, wherein the first plurality of the first portions and the second portions and the second plurality of the first portions and the second portions are disposed such that the plurality of second quantum dots do not overlap the plurality of first quantum dots across an orthogonal axis, and the first polymer matrix has a refractive index within 2 of the first quantum dots and the second polymer matrix has a refractive index within 2 of the second quantum dots.

Aspect 29B. A multi-layer film consisting essentially of: a first quantum dot layer comprising a first plurality of first portions and a first plurality of second portions, the first portions comprising a plurality of first quantum dots and the second portions consisting essentially of a first polymer matrix and one or more additives, wherein the plurality of first portions and the plurality of second portions are disposed in an alternating pattern; and a second quantum dot layer disposed adjacent the first quantum dot layer, the second quantum dot layer comprising a second plurality of first portions and a second plurality of second portions, wherein the second plurality of first portions comprises a plurality of second quantum dots and wherein the second plurality of second portions consisting essentially of a second polymer matrix or consisting essentially of a second polymer matrix and one or more additives, wherein the second plurality of first portions and second plurality of second portions are disposed in an alternating pattern, wherein the first plurality of the first portions and the second portions and the second plurality of the first portions and the second portions are disposed such that the plurality of second quantum dots do not overlap the plurality of first quantum dots across an orthogonal axis, and the first polymer matrix has a refractive index within 2 of the first quantum dots and the second polymer matrix has a refractive index within 2 of the second quantum dots.

Aspect 29C. A multi-layer film consisting of: a first quantum dot layer comprising a first plurality of first portions and a first plurality of second portions, the first portions comprising a plurality of first quantum dots and the second portions consisting essentially of a first polymer matrix and one or more additives, wherein the plurality of first portions and the plurality of second portions are disposed in an alternating pattern; and a second quantum dot layer disposed adjacent the first quantum dot layer, the second quantum dot layer comprising a second plurality of first portions and a second plurality of second portions, wherein the second plurality of first portions comprises a plurality of second quantum dots and wherein the second plurality of second portions consisting essentially of a second polymer matrix or consisting essentially of a second polymer matrix and one or more additives, wherein the second plurality of first portions and second plurality of second portions are disposed in an alternating pattern, wherein the first plurality of the first portions and the second portions and the second plurality of the first portions and the second portions are disposed such that the plurality of second quantum dots do not overlap the plurality of first quantum dots across an orthogonal axis, and the first polymer matrix has a refractive index within 2 of the first quantum dots and the second polymer matrix has a refractive index within 2 of the second quantum dots.

Aspect 30A. A method for making a multi-layer film, comprising: forming a first quantum dot layer comprising a first polymer matrix and a plurality of first quantum dots disposed in the first polymer matrix, wherein the plurality of first quantum dots are spaced from each other within the first polymer matrix to define gaps there between and the plurality of first quantum dots emit first secondary light upon excitation by light produced from a light source; and forming a second quantum dot layer disposed adjacent the first quantum dot layer, the second quantum dot layer comprising a second polymer matrix and a plurality of second quantum dots disposed in the second polymer matrix such that at least a portion of the plurality of second quantum dots align with the gaps defined in the first polymer matrix along an axis that is orthogonal to the first quantum dot layer and the second quantum dot layer, and the plurality of second quantum dots emit second secondary light upon excitation by light produced from the light source; wherein a peak wavelength of the first secondary light is higher than a peak wavelength of the second secondary light and the first quantum dot layer is placed in closer adjacency to the light source than the second quantum dot layer, the plurality of second quantum dots do not substantially overlap the plurality of first quantum dots along an axis orthogonal to the first quantum dot layer and the second quantum dot layer, the plurality of first quantum dots are spaced at a minimum of one radius of a first quantum dot and the plurality of second quantum dots are spaced at a minimum of one radius of a second quantum dot, and the first polymer matrix has a refractive index within 2 of the first quantum dots and the second polymer matrix has a refractive index within 2 of the second quantum dots.

Aspect 30B. A method for making a multi-layer film, consisting essentially of: forming a first quantum dot layer comprising a first polymer matrix and a plurality of first quantum dots disposed in the first polymer matrix, wherein the plurality of first quantum dots are spaced from each other within the first polymer matrix to define gaps there between and the plurality of first quantum dots emit first secondary light upon excitation by light produced from a light source; and forming a second quantum dot layer disposed adjacent the first quantum dot layer, the second quantum dot layer comprising a second polymer matrix and a plurality of second quantum dots disposed in the second polymer matrix such that at least a portion of the plurality of second quantum dots align with the gaps defined in the first polymer matrix along an axis that is orthogonal to the first quantum dot layer and the second quantum dot layer, and the plurality of second quantum dots emit second secondary light upon excitation by light produced from the light source; wherein a peak wavelength of the first secondary light is higher than a peak wavelength of the second secondary light and the first quantum dot layer is placed in closer adjacency to the light source than the second quantum dot layer, the plurality of second quantum dots do not substantially overlap the plurality of first quantum dots along an axis orthogonal to the first quantum dot layer and the second quantum dot layer, the plurality of first quantum dots are spaced at a minimum of one radius of a first quantum dot and the plurality of second quantum dots are spaced at a minimum of one radius of a second quantum dot, and the first polymer matrix has a refractive index within 2 of the first quantum dots and the second polymer matrix has a refractive index within 2 of the second quantum dots.

Aspect 30C. A method for making a multi-layer film, consisting of: forming a first quantum dot layer comprising a first polymer matrix and a plurality of first quantum dots disposed in the first polymer matrix, wherein the plurality of first quantum dots are spaced from each other within the first polymer matrix to define gaps there between and the plurality of first quantum dots emit first secondary light upon excitation by light produced from a light source; and forming a second quantum dot layer disposed adjacent the first quantum dot layer, the second quantum dot layer comprising a second polymer matrix and a plurality of second quantum dots disposed in the second polymer matrix such that at least a portion of the plurality of second quantum dots align with the gaps defined in the first polymer matrix along an axis that is orthogonal to the first quantum dot layer and the second quantum dot layer, and the plurality of second quantum dots emit second secondary light upon excitation by light produced from the light source; wherein a peak wavelength of the first secondary light is higher than a peak wavelength of the second secondary light and the first quantum dot layer is placed in closer adjacency to the light source than the second quantum dot layer, the plurality of second quantum dots do not substantially overlap the plurality of first quantum dots along an axis orthogonal to the first quantum dot layer and the second quantum dot layer, the plurality of first quantum dots are spaced at a minimum of one radius of a first quantum dot and the plurality of second quantum dots are spaced at a minimum of one radius of a second quantum dot, and the first polymer matrix has a refractive index within 2 of the first quantum dots and the second polymer matrix has a refractive index within 2 of the second quantum dots.

Aspect 31. The method of any one of aspects 28A-30C, wherein the first quantum dot layer is disposed adjacent a blue light emitting source and the first quantum dot layer is closer in distance to the blue light emitting source than the second quantum dot layer.

Aspect 32. The method of any one of aspects 28A-31, wherein the first polymer matrix has a refractive index within 0.5 of the first quantum dots and the second polymer matrix has a refractive index within 0.5 of the second quantum dots.

Aspect 33. The method of any one of aspects 28A-31, wherein the first polymer matrix has a refractive index within about 0.5 of the first quantum dots and the second polymer matrix has a refractive index within about 0.5 of the second quantum dots.

Aspect 34. The method of any one of aspects 28A-33, further comprising at least a third quantum dot layer, wherein the third quantum dot layer is disposed adjacent the second quantum dot layer, the third quantum dot layer comprises a plurality of at least third quantum dots that emit at least third secondary light upon excitation of light produced by the light source, and a peak wavelength of the third secondary light in the third quantum dot layer is lower than the peak wavelength of secondary light in an adjacent layer that is closer to the light source.

Aspect 35. The method of any one of aspects 28A-34, wherein at least a portion of the plurality of first quantum dots is larger than at least a portion of the plurality of second quantum dots.

Aspect 36. The method of any one of aspects 28A-35, wherein the plurality of first quantum dots comprises quantum dots have a size from about 3 nanometers (nm) to about 11 nm.

Aspect 37. The method of any one of aspects 28A-35, wherein the plurality of first quantum dots comprises quantum dots have a size from 3 nanometers (nm) to 11 nm.

Aspect 38. The method of any one of aspects 28A-37, wherein the first plurality of quantum dots comprise red phosphor with a peak emission wavelength between about 600 nm to about 750 nm.

Aspect 39. The method of any one of aspects 28A-37, wherein the first plurality of quantum dots comprise red phosphor with a peak emission wavelength between 600 nm to 750 nm.

Aspect 40. The method of any one of aspects 28A-39, wherein the second plurality of quantum dots comprise quantum dots sized from about 1 nm to about 8 nm.

Aspect 41. The method of any one of aspects 28A-40, wherein the second plurality of quantum dots comprise green phosphor with a peak emission wavelength between about 490 nm to about 580 nm.

Aspect 42. The method of any one of aspects 28A-41, wherein the second plurality of quantum dots comprise green phosphor with a peak emission wavelength between 490 nm to 580 nm.

Aspect 43. The method of any one of aspects 28A-42, wherein one or both of the plurality of first quantum dots and the plurality of second quantum dots are disposed in their respective quantum dot layer by way of a printing process, an extrusion process or a melt extrusion process, a solution-cast process, a lithography process or a polymerization process.

Aspect 44. The method of any one of aspects 28A-43, further comprising one or more barrier layers that enclose one or more of the first quantum dot layer or the second quantum dot layer.

Aspect 45. The method of any one of aspects 28A-44, wherein one or both of the first polymer matrix or the second polymer matrix comprises polycarbonate, acrylic (polymethylmethacrylate), polyimide, polyetherimide, polythiophene, epoxy, polyvinyl, poly-diacetylene, polyphenylene, polypeptide, polysaccharide, polysiloxane, polystyrene, polyethylene, polypropylene, polyacrylamide, polypyrrole, polyimidazole, polyphosphate poly(N-vinyl carbazole), polyethylene terephthalate, polybutylene terephthalate, polyurethane prepared from aliphatic and cycloaliphatic isocyanates, butyrate, (glycol modified polyethylene terephthalate), poly(maleic acid-alt-octadecene), ligand integrated polynorbornenes, polyamines, thiolated polyphenols, and functionalized ionic polymers, or poly(vinyl pyrrolidone) or a combination thereof.

Aspect 46. The multi-layer film of any one of aspects 28A-45, wherein one or both of the plurality of first quantum dots and the plurality of second quantum dots comprise CdS, CdSe, CdTe, ZnS, ZnSe, ZnTe, ZnO, HgS, HgSe, HgTe, GaN, GaP, GaAs, GaSb, AlN, AlP, AlAs, AlSb, InN, InP, InAs, InSb, SnS, SnSe, SnTe, PbS, PbSe, PbTe, SiC, SiGe, GaAs, GaP, GaAs, GaSb, HgS, HgSe, HgTe, InAs, InP, InSb, AlAs, alloys thereof, and mixtures thereof.

Aspect 47. The multi-layer film of any one of aspects 28A-46, wherein one or both of the plurality of first quantum dots and the plurality of second quantum dots comprise a core-shell structure.

Aspect 48. The multi-layer film of any one of aspects 28A-47, wherein one or both of the first polymer matrix and the second polymer matrix further comprise a refractive index-modifying additive.

Aspect 49. The multi-layer film of any one of aspects 28A-48, wherein the first polymer matrix is selected to be compatible to a ligand encapsulating the first quantum dots.

Aspect 50. The multi-layer film of any one of aspects 28A-49, wherein the second polymer matrix is selected to be compatible to a ligand encapsulating the second quantum dots.

Aspect 51. The multi-layer film of any one of claims 28A-50, wherein the plurality of first quantum dots comprises a first encapsulant material and the plurality of second quantum dots comprises a second encapsulant material, wherein the first and second encapsulant materials comprise different polymers

Aspect 52. An article including the multi-layer film formed by a method according to of any one of aspects 28A-51.

### Definitions

It is to be understood that the terminology used herein is for the purpose of describing particular aspects only and is not intended to be limiting. As used in the specification and in the claims, the term “comprising” can include the embodiments “consisting of” and “consisting essentially of” Unless defined otherwise, all technical and scientific terms used herein have the same meaning as commonly understood by one of ordinary skill in the art to which this disclosure belongs. In this specification and in the claims which follow, reference will be made to a number of terms which shall be defined herein.

Throughout this document, values expressed in a range format should be interpreted in a flexible manner to include not only the numerical values explicitly recited as the limits of the range, but also to include all the individual numerical values or sub-ranges encompassed within that range as if each numerical value and sub-range is explicitly recited. For example, a range of “about 0.1% to about 5%” or “about 0.1% to 5%” should be interpreted to include not just about 0.1% to about 5%, but also the individual values (e.g., 1%, 2%, 3%, and 4%) and the sub-ranges (e.g., 0.1% to 0.5%, 1.1% to 2.2%, 3.3% to 4.4%) within the indicated range. The statement “about X to Y” has the same meaning as “about X to about Y,” unless indicated otherwise. Likewise, the statement “about X, Y, or about Z” has the same meaning as “about X, about Y, or about Z,” unless indicated otherwise. The term “about” as used herein can allow for a degree of variability in a value or range, for example, within 10%, within 5%, or within 1% of a stated value or of a stated limit of a range, and includes the exact stated value or range.

Ranges can be expressed herein as from one particular value to another particular value. When such a range is expressed, another aspect includes from the one particular value and/or to the other particular value. Similarly, when values are expressed as approximations, by use of the antecedent ‘about,’ it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that each unit between two particular units are also disclosed. For example, if 10 and 15 are disclosed, then 11, 12, 13, and 14 are also disclosed.

As used herein, the terms “about” and “at or about” mean that the amount or value in question can be the value designated some other value approximately or about the same. It is generally understood, as used herein, that it is the nominal value indicated ±5% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

In this document, the terms “a,” “an,” or “the” are used to include one or more than one unless the context clearly dictates otherwise. The term “or” is used to refer to a nonexclusive “or” unless otherwise indicated. The statement “at least one of A and B” has the same meaning as “A, B, or A and B.” In addition, it is to be understood that the phraseology or terminology employed herein, and not otherwise defined, is for the purpose of description only and not of limitation. Any use of section headings is intended to aid reading of the document and is not to be interpreted as limiting; information that is relevant to a section heading may occur within or outside of that particular section.

In the methods described herein, the acts may be carried out in any order without departing from the principles of the disclosure, except when a temporal or operational sequence is explicitly recited. Furthermore, specified acts may be carried out concurrently unless explicit claim language recites that they be carried out separately. For example, a claimed act of doing X and a claimed act of doing Y may be conducted simultaneously within a single operation, and the resulting process will fall within the literal scope of the claimed process.

The term “substantially” as used herein refers to a majority of, or mostly, or almost completely, as in at least about 50%, 60%, 70%, 80%, 90%, 95%, 96%, 97%, 98%, 99%, 99.5%, 99.9%, 99.99%, or at least about 99.999% or more, or 100%. The phrase “substantially overlap” may refer to the amount of overlap in an orthogonal direction to the layers of the multi-layer film wherein the quantum dots extend over so as to cover partly. In other words, “substantially overlap” may indicate that quantum dots are within same portion of the light path from a light source such that a portion of the quantum dot extends or projects over another thereby obstructing (or partially obstructing) the light path to the other quantum dot. Where there is “substantially no overlap,” quantum dots do not obstruct one another from the light path in the plane orthogonal to the layers of the multi-layer film. The amount of overlap may be measured and quantified by absorption and fluorescence quantum yield measurements.

As used herein, “peak wavelength” may refer to the wavelength at which an observed light spectrum reaches its highest intensity. For a body emitting light, such as a quantum dot, peak wavelength may refer to the spectral line having the greatest emission power. “Peak emission wavelength” may be used interchangeably for “peak wavelength.” A peak wavelength may be determined using a spectrofluorometer. A number of standards are available for measuring peak wavelength. An exemplary standard is ASTM E388-04 (2015).

The term “organic group” as used herein refers to any carbon-containing functional group. For example, an oxygen-containing group such as an alkoxy group, aryloxy group, arylkyloxy group, oxo(carbonyl) group, a carboxyl group including a carboxylic acid, carboxylate, and a carboxylate ester; a sulfur-containing group such as an alkyl and aryl sulfide group; and other heteroatom-containing groups. Non-limiting examples of organic groups include OR, OOR, OC(O)N(R)₂, CN, CF₃, OCF₃, R, C(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, C(═NOR)R, and substituted or unsubstituted (C₁-C₁₀₀)hydrocarbyl, wherein R may be hydrogen (in examples that include other carbon atoms) or a carbon-based moiety, and wherein the carbon-based moiety may be substituted or unsubstituted.

The term “substituted” as used herein in conjunction with a molecule or an organic group as defined herein refers to the state in which one or more hydrogen atoms contained therein are replaced by one or more non-hydrogen atoms. The term “functional group” or “substituent” as used herein refers to a group that may be or is substituted onto a molecule or onto an organic group. Examples of substituents or functional groups include, but are not limited to, a halogen (e.g., F, Cl, Br, and I); an oxygen atom in groups such as hydroxy groups, alkoxy groups, aryloxy groups, aralkyloxy groups, oxo(carbonyl) groups, carboxyl groups including carboxylic acids, carboxylates, and carboxylate esters; a sulfur atom in groups such as thiol groups, alkyl and aryl sulfide groups, sulfoxide groups, sulfone groups, sulfonyl groups, and sulfonamide groups; a nitrogen atom in groups such as amines, hydroxyamines, nitriles, nitro groups, N-oxides, hydrazides, azides, and enamines; and other heteroatoms in various other groups. Non-limiting examples of substituents that may be bonded to a substituted carbon (or other) atom include F, Cl, Br, I, OR, OC(O)N(R)₂, CN, NO, NO₂, ONO₂, azido, CF₃, OCF₃, R, O (oxo), S (thiono), C(O), S(O), methylenedioxy, ethylenedioxy, N(R)₂, SR, SOR, SO₂R, SO₂N(R)₂, SO₃R, C(O)R, C(O)C(O)R, C(O)CH₂C(O)R, C(S)R, C(O)OR, OC(O)R, C(O)N(R)₂, OC(O)N(R)₂, C(S)N(R)₂, (CH₂)₀₋₂N(R)C(O)R, (CH₂)₀₋₂N(R)N(R)₂, N(R)N(R)C(O)R, N(R)N(R)C(O)OR, N(R)N(R)CON(R)₂, N(R)SO₂R, N(R)SO₂N(R)₂, N(R)C(O)OR, N(R)C(O)R, N(R)C(S)R, N(R)C(O)N(R)₂, N(R)C(S)N(R)₂, N(COR)COR, N(OR)R, C(═NH)N(R)₂, C(O)N(OR)R, and C(═NOR)R, wherein R may be hydrogen or a carbon-based moiety; for example, R may be hydrogen, (C₁-C₁₀₀)hydrocarbyl, alkyl, acyl, cycloalkyl, aryl, aralkyl, heterocyclyl, heteroaryl, or heteroarylalkyl; or wherein two R groups bonded to a nitrogen atom or to adjacent nitrogen atoms may together with the nitrogen atom or atoms form a heterocyclyl.

The term “alkyl” as used herein refers to straight chain and branched alkyl groups and cycloalkyl groups. Examples of straight chain alkyl groups include those with from 1 to 8 carbon atoms such as methyl, ethyl, n-propyl, n-butyl, n-pentyl, n-hexyl, n-heptyl, and n-octyl groups. Examples of branched alkyl groups include, but are not limited to, isopropyl, iso-butyl, sec-butyl, t-butyl, neopentyl, isopentyl, and 2,2-dimethylpropyl groups.

The term “alkenyl” as used herein refers to straight and branched chain and cyclic alkyl groups as defined herein, except that at least one double bond exists between two carbon atoms.

The term “acyl” as used herein refers to a group containing a carbonyl moiety wherein the group is bonded via the carbonyl carbon atom.

The term “cycloalkyl” as used herein refers to cyclic alkyl groups such as, but not limited to, cyclopropyl, cyclobutyl, cyclopentyl, cyclohexyl, cycloheptyl, and cyclooctyl groups. In some aspects, the cycloalkyl group may have 3 to about 8-12 ring members, whereas in other aspects the number of ring carbon atoms range from 3 to 4, 5, 6, or 7

The term “aryl” as used herein refers to cyclic aromatic hydrocarbon groups that do not contain heteroatoms in the ring. Thus aryl groups include, but are not limited to, phenyl, azulenyl, heptalenyl, biphenyl, indacenyl, fluorenyl, phenanthrenyl, triphenylenyl, pyrenyl, naphthacenyl, chrysenyl, biphenylenyl, anthracenyl, and naphthyl groups.

The term “heterocyclyl” as used herein refers to aromatic and non-aromatic ring compounds containing three or more ring members, of which one or more is a heteroatom such as, but not limited to, N, O, and S.

The term “alkoxy” as used herein refers to an oxygen atom connected to an alkyl group, including a cycloalkyl group, as are defined herein.

The terms “halo,” “halogen,” or “halide” group, as used herein, by themselves or as part of another substituent, mean, unless otherwise stated, a fluorine, chlorine, bromine, or iodine atom.

The term “haloalkyl” group, as used herein, includes mono-halo alkyl groups, poly-halo alkyl groups wherein all halo atoms may be the same or different, and per-halo alkyl groups, wherein all hydrogen atoms are replaced by halogen atoms, such as fluoro. Examples of haloalkyl include trifluoromethyl, 1,1-dichloroethyl, 1,2-dichloroethyl, 1,3-dibromo-3,3-difluoropropyl, perfluorobutyl, and the like.

The term “hydrocarbon” or “hydrocarbyl” as used herein refers to a molecule or functional group, respectively, which includes carbon and hydrogen atoms. The term may also refer to a molecule or functional group that normally includes both carbon and hydrogen atoms but wherein all the hydrogen atoms are substituted with other functional groups.

As used herein, the term “hydrocarbyl” refers to a functional group derived from a straight chain, branched, or cyclic hydrocarbon, and may be alkyl, alkenyl, alkynyl, aryl, cycloalkyl, acyl, or any combination thereof. Hydrocarbyl groups may be shown as (Cₐ-C_{b})hydrocarbyl, wherein a and b are integers and mean having any of a to b number of carbon atoms. For example, (C₁-C₄)hydrocarbyl means the hydrocarbyl group may be methyl (C₁), ethyl (C₂), propyl (C₃), or butyl (C₄), and (C₀-C_{b})hydrocarbyl means in certain aspects there is no hydrocarbyl group.

The term “number-average molecular weight” (Mₙ) as used herein refers to the ordinary arithmetic mean of the molecular weight of individual molecules in a sample. It is defined as the total weight of all molecules in a sample divided by the total number of molecules in the sample. Experimentally, Mₙ is determined by analyzing a sample divided into molecular weight fractions of species i having nᵢ molecules of molecular weight Mᵢ through the formula Mₙ=Mᵢnᵢ/Σnᵢ. The Mₙ may be measured by a variety of well-known methods including gel permeation chromatography, spectroscopic end group analysis, and osmometry. If unspecified, molecular weights of polymers given herein are number-average molecular weights.

The term “weight-average molecular weight” as used herein refers to M_{w}, which is equal to ΣMᵢ²nᵢ/ΣMᵢnᵢ, where nᵢ is the number of molecules of molecular weight Mᵢ. In various examples, the weight-average molecular weight may be determined using light scattering, small angle neutron scattering, X-ray scattering, and sedimentation velocity.

As used herein, “quantum dots” or “QDs” (or QD, singular) refers to semiconductor nanometer structures that confine conduction band electrons, valence band holes and excitons in three spatial directions. This confinement may be attributed to the factors: electrostatic potential (generated by external electrodes, doping, stress or impurity), interface between two different semiconductor materials (for example in self-assembling quantum dots), semiconductor surface (such as semiconductor nanocrystal) or a combination of the above. QD's have a discrete quantized energy spectrum, and the corresponding wave function is located in the quantum dot in space, but extends across several crystal lattice periods. One quantum dot has a small amount of electrons (e.g., from about 1 to about 100), holes or hole-electron pairs, that is, the quantity of electricity it carries is an integral multiple of element of electric-charges. A quantum dot is a nanoparticle comprised of II-VI group or III-V group elements. The particle diameter of a quantum dot is generally between 1 nm and 10 nm. Since electrons and holes are quantumly confined, the continuous energy band structure is transformed into a discrete energy level structure with molecular characteristics, which may emit fluorescence after being stimulated.

The term “radiation” as used herein refers to energetic particles travelling through a medium or space. Examples of radiation are visible light, infrared light, microwaves, radio waves, very low frequency waves, extremely low frequency waves, thermal radiation (heat), and black-body radiation.

The term “UV light” as used herein refers to ultraviolet light, which is electromagnetic radiation with a wavelength of about 10 nm to about 400 nm.

The term “cure” as used herein refers to exposing to radiation in any form, heating, or undergoing a physical or chemical reaction that results in hardening or an increase in viscosity.

The term “coating” as used herein refers to a continuous or discontinuous layer of material on the coated surface, wherein the layer of material may penetrate the surface and may fill areas such as pores, wherein the layer of material may have any three-dimensional shape, including a flat or curved plane. In one example, a coating may be applied to one or more surfaces, any of which may be porous or nonporous, by immersion in a bath of coating material.

The term “surface” as used herein refers to a boundary or side of an object, wherein the boundary or side may have any perimeter shape and may have any three-dimensional shape, including flat, curved, or angular, wherein the boundary or side may be continuous or discontinuous. While the term surface generally refers to the outermost boundary of an object with no implied depth, when the term ‘pores’ is used in reference to a surface, it refers to both the surface opening and the depth to which the pores extend beneath the surface into the substrate.

As used herein, the term “transparent” means that the level of transmittance for a disclosed composition is greater than 50%. It is preferred that the transmittance be at least 60%, 70%, 80%, 85%, 90%, or 95%, or any range of transmittance values derived from the above exemplified values. In the definition of “transparent”, the term “transmittance” refers to the amount of incident light that passes through a sample measured in accordance with ASTM D1003 at a thickness of 3.2 millimeters.

As used herein, the term “refractive index” The terms “refractive index” or “index of refraction” as used herein refer to a dimensionless number that is a measure of the speed of light in that substance or medium. It is typically expressed as a ratio of the speed of light in vacuum relative to that in the considered substance or medium. This may be written mathematically as:

n=speed of light in a vacuum/speed of light in medium.

As used herein, the term “polymer” refers to a molecule having at least one repeating unit and may include copolymers and homopolymers. The polymers described herein may terminate in any suitable way. In some aspects, the polymers may terminate with an end group that is independently chosen from a suitable polymerization initiator, —H, —OH, a substituted or unsubstituted (C₁-C₂₀)hydrocarbyl (e.g., (C₁-C₁₀)alkyl or (C₆-C₂₀)aryl) interrupted with 0, 1, 2, or 3 groups independently selected from —O—, substituted or unsubstituted —NH—, and —S—, a poly(substituted or unsubstituted (C₁-C₂₀)hydrocarbyloxy), and a poly(substituted or unsubstituted (C₁-C₂₀)hydrocarbylamino).

Illustrative types of polyethylene include, for example, ultra-high molecular weight polyethylene (UHMWPE, for example, a molar mass between 3.5 and 7.5 million atomic mass units), ultra-low molecular weight polyethylene (ULMWPE), high molecular weight polyethylene (HMWPE), high density polyethylene (HDPE, for example, a density of about 0.93 to 0.97 grams per cubic centimeter (g/cm³) or 970 kilograms per cubic meter (kg/m³)), high density cross-linked polyethylene (HDXLPE, for example, a density of about 0.938 to about 0.946 g/cm³), cross-linked polyethylene (PEX or XLPE, for example, a degree of cross-linking of between 65 and 89% according to ASTM F876), medium density polyethylene (MDPE, for example, a density of 0.926 to 0.940 g/cm³), low density polyethylene (LDPE, for example, about 0.910 g/cm³ to 0.940 g/cm³), linear low density polyethylene (LLDPE) and very low density polyethylene (VLDPE, for example, a density of about 0.880 to 0.915 g/cm³).

### Examples

In one example, an optical construction of the present disclosure may comprise a blue LED light with peak wavelength at 450 nm and an acrylic barrier film with thickness at 50 μm disposed adjacent thereto. Adjacent the barrier layer may be a first quantum dot layer comprising epoxy resin and a plurality of first quantum dots comprising cadmium selenide disposed therein. The cadmium selenide quantum dots may have a diameter of 7.5 nm and peak emission wavelength at 650 nm. The first quantum dot layer may have a thickness of 50 μm. A second quantum dot layer may be adjacent the first quantum dot layer. The second quantum dot layer may comprise a plurality of second quantum dots comprising cadmium selenide. The plurality of second quantum dots may have a diameter of 2.9 nm and peak emission wavelength at 525 nm embedded in epoxy resin. The thickness of the second quantum dot layer may be about 50 μm. A second barrier film comprising aluminum oxide and a thickness of about 10 nm may be disposed adjacent the quantum dot layers.

Method examples described herein may be machine or computer-implemented at least in part. Some examples may include a computer-readable medium or machine-readable medium encoded with instructions operable to configure an electronic device to perform methods as described in the above examples. An implementation of such methods may an include code, such as microcode, assembly language code, a higher-level language code, or the like. Such code may include computer readable instructions for performing various methods. The code may form portions of computer program products. Further, in an example, the code may be tangibly stored on one or more volatile, non-transitory, or non-volatile tangible computer-readable media, such as during execution or at other times. Examples of tangible computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

The above description is intended to be illustrative, and not restrictive. For example, the above-described examples (or one or more aspects thereof) may be used in combination with each other. Other aspects may be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed aspect. Thus, the following claims are hereby incorporated into the Detailed Description as examples or aspects, with each claim standing on its own as a separate aspect, and it is contemplated that such aspects may be combined with each other in various combinations or permutations. The scope of the disclosure should be determined with reference to the appended claims, along with the full scope of equivalents to which such claims are entitled.

1. A multi-layer film comprising:
a first quantum dot layer comprising a first polymer matrix and a plurality of first quantum dots disposed in the first polymer matrix, wherein the plurality of first quantum dots are spaced from each other within the first polymer matrix to define gaps there between and the plurality of first quantum dots emit a first secondary light upon excitation by light produced from a light source; and
a second quantum dot layer disposed adjacent the first quantum dot layer, the second quantum dot layer comprising a second polymer matrix and a plurality of second quantum dots disposed in the second polymer matrix such that at least a portion of the plurality of second quantum dots align with the gaps defined in the first polymer matrix along an axis that is orthogonal to the first quantum dot layer and the second quantum dot layer, and the plurality of second quantum dots emit a second secondary light upon excitation by light produced from the light source;
wherein
a peak wavelength of the first secondary light is higher than a peak wavelength of the second secondary light and the first quantum dot layer is placed in closer adjacency to the light source than the second quantum dot layer,
the plurality of second quantum dots do not substantially overlap the plurality of first quantum dots along an axis orthogonal to the first quantum dot layer and the second quantum dot layer,
the plurality of first quantum dots are spaced at a minimum of one radius of a first quantum dot and the plurality of second quantum dots are spaced at a minimum of one radius of a second quantum dot, and
the first polymer matrix has a refractive index within 2 of the first quantum dots and the second polymer matrix has a refractive index within 2 of the second quantum dots.

2. The multi-layer film of claim 1, wherein the first quantum dot layer is disposed adjacent a blue light emitting source and the first quantum dot layer is closer in distance to the blue light emitting source than the second quantum dot layer.

3. The multi-layer film of claim 1, further comprising at least a third quantum dot layer, wherein
the third quantum dot layer is disposed adjacent the second quantum dot layer,
the third quantum dot layer comprises a plurality of at least third quantum dots that emit at least third secondary light upon excitation of light produced by the light source, and
a peak wavelength of the third secondary light in the third quantum dot layer is lower than the peak wavelength of the second secondary light in an adjacent layer that is closer to the light source.

4. The multi-layer film of claim 1, wherein the first polymer matrix has a refractive index within 0.5 of the first quantum dots and the second polymer matrix has a refractive index within 0.5 of the second quantum dots.

5. The multi-layer film of claim 1, wherein the plurality of first quantum dots comprises quantum dots have a size from about 3 nanometers (nm) to about 11 nm.

6. The multi-layer film of claim 1, wherein the first plurality of quantum dots comprise red phosphor with a peak wavelength between about 600 nm to about 750 nm.

7. The multi-layer film of claim 1, wherein the second plurality of quantum dots comprise quantum dots sized from about 1 nm to about 8 nm.

8. The multi-layer film of claim 1, wherein the second plurality of quantum dots comprise green phosphor with a peak emission wavelength between about 490 nm to about 580 nm.

9. The multi-layer film of claim 1, wherein one or both of the plurality of first quantum dots and the plurality of second quantum dots are disposed in their respective quantum dot layer by way of a printing process, a lithography process, an extrusion process, a solution-cast process, or a polymerization process.

10. The multi-layer film of claim 1, further comprising one or more barrier layers that enclose one or more of the first quantum dot layer or the second quantum dot layer.

11. The multi-layer film of claim 1, wherein one or both of the first polymer matrix or the second polymer matrix comprises polycarbonate, acrylic (polymethylmethacrylate), polyimide, polyetherimide, polythiophene, epoxy, polyvinyl, poly-diacetylene, polyphenylene, polypeptide, polysaccharide, polysiloxane, polystyrene, polyethylene, polypropylene, polyacrylamide, polypyrrole, polyimidazole, polyphosphate poly(N-vinyl carbazole), polyethylene terephthalate, polybutylene terephthalate, polyurethane prepared from aliphatic and cycloaliphatic isocyanates, butyrate, (glycol modified polyethylene terephthalate), poly(maleic acid-alt-octadecene), ligand integrated polynorbornenes, polyamines, thiolated polyphenols, and functionalized ionic polymers, or poly(vinyl pyrrolidone) or a combination thereof.

12. The multi-layer film of claim 1, wherein one or both of the plurality of first quantum dots and the plurality of second quantum dots comprise CdS, CdSe, CdTe, ZnS, ZnSe, ZnTe, ZnO, HgS, HgSe, HgTe, GaN, GaP, GaAs, GaSb, AlN, AlP, AlAs, AlSb, InN, InP, InAs, InSb, SnS, SnSe, SnTe, PbS, PbSe, PbTe, SiC, SiGe, GaAs, GaP, GaAs, GaSb, HgS, HgSe, HgTe, InAs, InP, InSb, AlAs, alloys thereof, and mixtures thereof.

13. The multi-layer film of claim 1, wherein one or both of the plurality of first quantum dots and the plurality of second quantum dots comprise a core-shell structure.

14. The multi-layer film of claim 1, wherein one or both of the first polymer matrix and the second polymer matrix further comprise a refractive index-modifying additive.

15. The multi-layer film of claim 1, wherein the first polymer matrix is selected to be compatible to a ligand encapsulating the first quantum dots.

16. The multi-layer film of claim 1, wherein the second polymer matrix is selected to be compatible to a ligand encapsulating the second quantum dots.

17. The multi-layer film of claim 1, wherein the plurality of first quantum dots comprises a first encapsulant material and the plurality of second quantum dots comprises a second encapsulant material, wherein the first and second encapsulant materials comprise different polymers.

18. An article including the multi-layer film of claim 1.

19. A multi-layer film comprising:
a first quantum dot layer comprising a first polymer matrix and a plurality of first quantum dots disposed in the first polymer matrix, wherein the plurality of first quantum dots are spaced from each other within the first polymer matrix to define gaps there between; and
a second quantum dot layer disposed adjacent the first quantum dot layer, the second quantum dot layer comprising a second polymer matrix and a plurality of second quantum dots disposed in the second polymer matrix such that at least a portion of the plurality of second quantum dots align with the gaps defined in the first polymer matrix along an axis that is orthogonal to the first quantum dot layer and the second quantum dot layer,
wherein
the plurality of first quantum dots are spaced at a minimum of one radius of a first quantum dot and the plurality of second quantum dots are spaced at a minimum of one radius of a second quantum dot, and
the first polymer matrix has a refractive index within 2 of the first quantum dots and the second polymer matrix has a refractive index within 2 of the second quantum dots.

20. A multi-layer film comprising:
a first quantum dot layer comprising a first plurality of first portions and a first plurality of second portions, the first portions comprising a plurality of first quantum dots and the second portions consisting essentially of a first polymer matrix and one or more additives, wherein the first plurality of first portions and the first plurality of second portions are disposed in an alternating pattern; and
a second quantum dot layer disposed adjacent the first quantum dot layer, the second quantum dot layer comprising a second plurality of first portions and a second plurality of second portions, wherein the second plurality of first portions comprises a plurality of second quantum dots and wherein the second plurality of second portions consists essentially of a second polymer matrix and one or more additives, wherein the second plurality of first portions and second plurality of second portions are disposed in an alternating pattern,
wherein
the first plurality of the first portions and the second portions and the second plurality of the first portions and the second portions are disposed such that the plurality of second quantum dots do not overlap the plurality of first quantum dots across an orthogonal axis, and
the first polymer matrix has a refractive index within 2 of the first quantum dots and the second polymer matrix has a refractive index within 2 of the second quantum dots.
